(19) United States
(12) Patent Application Publication
(10) Pub. No.: US 2015/0332362 A1
(43) Pub. Date: Nov. 19, 2015

(54) SYSTEM AND METHOD FOR FACILITATING SALE OF GOODS

(71) Applicant: Reverb.com LLC, Chicago, IL (US)

(72) Inventor: David Kalt, Chicago, IL (US)

(21) Appl. No.: 14/280,203

(22) Filed: May 16, 2014

(51) Int. Cl. G06Q 30/06

(52) U.S. Cl. CPC G06Q 30/0611

(57) ABSTRACT

Systems, devices, and methods are disclosed for facilitating the communication between two or more users of an electronic marketplace. The communication between the two or more users is implemented to promote a sale of a product offered for sale on the electronic marketplace. Systems, device, and methods are also disclosed for providing an advantage for one or more product listings being offered for sale on the electronic marketplace. The advantage may place the product listing within a preferential location on a display of the electronic marketplace.

### TECHNICAL FIELD

This disclosure generally relates to a system and method for facilitating the sale of goods from a seller to a buyer. More particularly, the system and method described throughout this disclosure are configured to allow a seller to communicate directly with a buyer to facilitate a sales transaction within an electronic marketplace. Further, the system and method described throughout this disclosure are configured to allow a seller to gain a marketable advantage over other product listings within an electronic marketplace.

### BACKGROUND

Offering a product for sale on an electronic (e.g., online) marketplace may allow a seller to advertise the product to a wider audience of buyers than if the product was simply offered for sale in a brick and mortar storefront. Yet the decision by the seller to place products for sale on an electronic marketplace model may offer up problems or issues that may be unique over the traditional brick and mortar storefront model.

### SUMMARY

This application is defined by the appended claims. The description summarizes aspects of the embodiments and should not be used to limit the claims. Other implementations are contemplated in accordance with the techniques described herein, as will be apparent to one having ordinary skill in the art upon examination of the following drawings and detailed description, and such implementations are intended to be within the scope of this application.

Exemplary embodiments provide systems and methods for allowing communication between a seller (e.g., the entity offering to sell a product) and buyer (e.g., the entity offering to buy the product) within an electronic marketplace. The exemplary embodiments may include a marketplace tool configured to allow the seller and buyer to engage in one or more rounds of communication before a newly negotiated selling price for the product is agreed upon. In some embodiments the seller may then offer the newly negotiated selling price to the buyer for acceptance.

Another exemplary embodiment may include an advantage tool for enhancing the marketing capabilities of a product being offered for sale on the electronic marketplace. The advantage tool may, for example, enhance the visibility of a product within a viewing screen of the electronic marketplace.

According to some embodiments, a computing apparatus may be provided comprising a memory configured to store processor executable instructions, a network interface configured to receive communications from user operated devices, and a processor in communication with the memory and the network interface. The processor may be configured to execute the processor executable instructions stored on the memory to present a product for sale by a seller under original sales terms; receive a buyer communication from a buyer operated device via the network interface; present the buyer communication to a seller operated device; in response to the buyer communication, receive a seller communication from the seller operated device via the network interface, the seller communication including new sales terms that override the original sales terms; and present the seller communication including the new sales terms to the buyer operated device.

According to some embodiments, a method for enhancing an electronic sales transaction comprises presenting a product for sale by a seller under original sales terms; receiving a buyer communication from a buyer operated device via a network interface; presenting the buyer communication to a seller operated device; in response to the buyer communication, receiving a seller communication from the seller operated device via the network interface, the seller communication including new sales terms that override the original sales terms; and present the seller communication including the new sales terms to the buyer operated device.

According to some embodiments, a computing device may be provided comprising a memory configured to store processor executable instructions, a network interface configured to receive communications from user operated devices, and a processor in communication with the memory and the network interface. The processor may be configured to execute the processor executable instructions stored on the memory to receive product listing information for a product listing that includes an impression value for the product listing; determine the product listing is eligible for an impression function when the impression value satisfies a threshold value; analyze the product listing information for selection of the impression function; select the product listing for the impression function based on the analysis, and control a display unit to present the product listing within a dedicated sub-display area within a general display in accordance to the impression function.

According to some embodiments, a method for providing an advantage for a product listing may comprise receiving product listing information for the product listing that includes an impression value for the product listing; determining the product listing is eligible for an impression function when the impression value satisfies a threshold value; analyzing the product listing information for selection of the impression function; selecting the product listing for the impression function based on the analysis, and controlling a display unit to present the product listing within a dedicated sub-display area within a general display in accordance to the impression function.

### DESCRIPTION OF THE DRAWINGS

For a better understanding of the invention, reference may be made to embodiments shown in the following drawings. The components in the drawings are not necessarily to scale and related elements may be omitted so as to emphasize and clearly illustrate the novel features described herein. In addition, system components can be variously arranged, as known in the art. In the figures, like referenced numerals may refer to like parts throughout the different figures unless otherwise specified.

FIG. 1 illustrates an exemplary network for implementing features described in this disclosure;

FIG. 2-1 illustrates an exemplary display for a marketplace tool according to some embodiments;

FIG. 2-2 illustrates an exemplary display for a marketplace tool according to some embodiments;

FIG. 2-3 illustrates an exemplary display for a marketplace tool according to some embodiments;

FIG. 3 illustrates an exemplary display for a marketplace tool according to some embodiments;

FIG. 4-1 illustrates an exemplary display for a marketplace tool according to some embodiments;

FIG. 4-2 illustrates an exemplary display for a marketplace tool according to some embodiments;

FIG. 5 illustrates an exemplary display for a marketplace tool according to some embodiments;

FIG. 6 illustrates an exemplary flow chart describing a process for a marketplace tool according to some embodiments;

FIG. 7 illustrates an exemplary display for an advantage tool according to some embodiments;

FIG. 8 illustrates an exemplary display for an advantage tool according to some embodiments;

FIG. 9 illustrates an exemplary statistical display for an advantage tool according to some embodiments;

FIG. 10 illustrates an exemplary budget display for an advantage tool according to some embodiments;

FIG. 11 illustrates an exemplary analytics display for an advantage tool according to some embodiments;

FIG. 12 illustrates an exemplary flow chart describing a process for an advantage tool according to some embodiments; and

FIG. 13 illustrates an exemplary block diagram including components of the boundary detection system according to some embodiments.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated. Not all of the depicted components described in this disclosure may be required, however, and some implementations may include additional, fewer, or different components from those expressly described in this disclosure. Variations in the arrangement and type of the components may be made without departing from the spirit or scope of the disclosure or claims as set forth herein.

An electronic marketplace may be created and operated as a space where sellers offer certain goods, products, and/or services for sale, and buyers browse and buy (i.e., accept offers for sale) such goods, products, and/or services that are offered for sale. Although the types of goods and services that are offered for sale may range from any number of categories and fields, in certain embodiments the electronic marketplace may be operated to promote certain categories or fields of goods and/or services. For example, the electronic marketplace may be created and operated to be geared towards the music industry. In this way, the products offered for sale may be tangible goods related to the music industry such as musical instruments, electronic equipment related to the music industry, or clothing apparel related to the music industry. Similarly, the services offered for sale on the electronic marketplace may be musical instrument lessons, musical instrument repair services, or offers to play musical performances. As mentioned, the electronic marketplace need not be limited to any one or more specific categories or fields. However, such niche electronic marketplaces may be created and operated according to some embodiments.

The electronic marketplace offers the benefit of allowing sellers and buyers to engage in transactions without having to physically meet in a brick and mortar storefront. For a seller (e.g., merchant or individual seller), the electronic marketplace offers the advantage of reduced overhead expenses. For example, the electronic marketplace may significantly reduce the need to pay for overhead expenses required for a traditional brick and mortar storefront such as rent, utility, and maintenance expenses. For the buyer, the electronic marketplace may offer the advantage of convenience. For example, the buyer may shop and buy products from the comforts of the buyer's home as long as the buyer has access to the electronic marketplace through the use of a computing device. Further, the savings that are enjoyed by the sellers from their reduced overhead expenses may be passed onto their buyers or clients in the form of reduced product or services costs. In this way, the buyers on an electronic marketplace may enjoy the additional advantage of lower costs in comparison to the same goods or services that would have been offered for sale in a traditional brick and mortar storefront.

In terms of both parties, the electronic marketplace may offer the benefit of increased geographical reach over traditional brick and mortar storefronts. For instance, the sellers may not be limited to only buyers that are within a physical proximity to the seller, and instead the sellers on the electronic marketplace may have access to buyers at any location where a network (e.g., internet) connection is available to access the electronic marketplace. Similarly, buyers may not be limited to shop only at brick and mortar storefronts that are within a physical proximity to the buyer, but rather buyers on the electronic marketplace may have access to any sellers that are operating on the electronic marketplace regardless of the sellers location.

Even with all of the potential advantages that an electronic marketplace may offer over the traditional brick and mortar storefront, electronic marketplaces may still lack the ability to promote the overall customer experience for buyers that may have been possible in a brick and mortar storefront. For instance, buyers on an electronic marketplace may have only been offered a single sales price for a good or service without the possibility of negotiating or offering different sales conditions, which may have been possible in a brick and mortar storefront with a live sales person. In these instances, buyers on the electronic marketplace were left with only a single choice of whether to accept or decline the single offered price. In other words, buyers on an electronic marketplace had limited, if any, opportunity to interact with a sales associate to ask questions and negotiate for different sales terms.

It follows that this disclosure describes systems, devices, processes, and methods for operating an electronic marketplace configured to provide both buyers and sellers with a more complete marketplace experience. More specifically, this disclosure describes a marketplace tool and an advantage tool that includes features for promoting a more complete marketplace experience for both buyers and sellers. It should be noted that although reference may be made to a product listing on the electronic marketplace, this product offering may correspond to any one or more of a tangible good, product, or service being offered by a seller on the electronic marketplace.

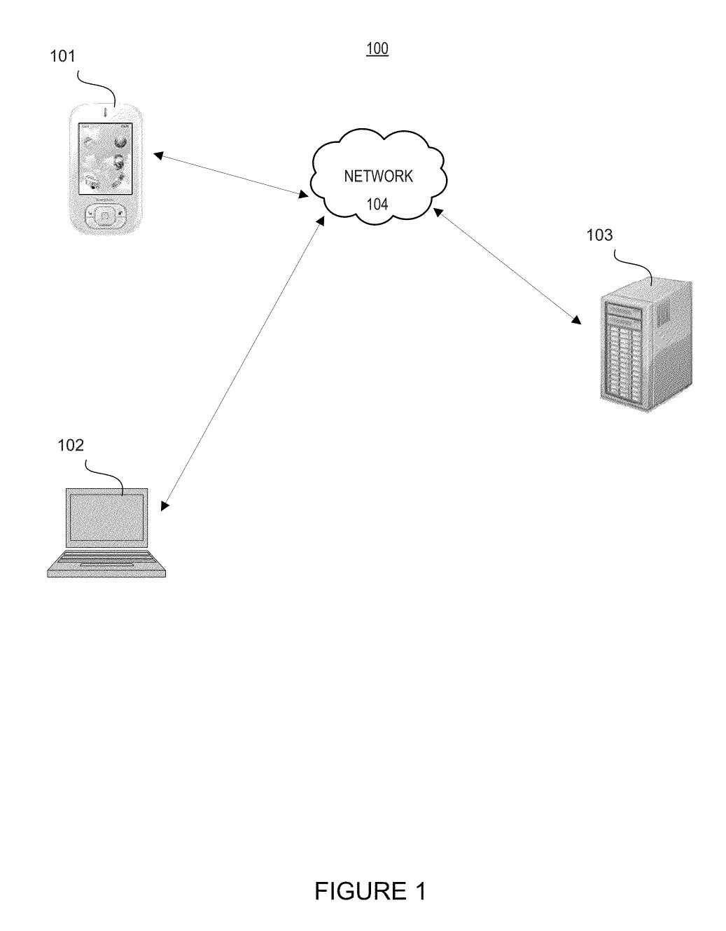

FIG. 1 illustrates a system 100 including a marketplace server 103, a user operated communication device 101 in the form of a mobile smartphone, and a user operated communication device in the form of a laptop computing device 102. FIG. 1 also illustrates a network 104 for allowing communication of information data between the marketplace server 103 and the communication devices 101 and 102. Although the marketplace server 103 is illustrated alone, it is within the scope of the disclosure to include one or more servers in communication with each other to comprise the marketplace server 103. Although the communication device 101 and 102 are illustrated in the form of a mobile smartphone and a laptop computing device, respectively, it is within the scope of this disclosure for the marketplace server 103 to communicate with other types of communication devices including, but not limited to, a personal computing device (e.g., Personal Computer (PC)), tablet computing device, personal digital assistant (PDA), kiosk, point of sale terminal, or other similar mobile or stationary communication devices.

Further, the network 104 may represent one or more networks that may be comprised of any combination of one or more of a cellular network, including standards-based networks (e.g., 2G, 3G, Universal Mobile Telecommunications System (UMTS), GSM (R) Association, Long Term Evolution (LTE) (TM), or more), WiMAX, Bluetooth, near field communication (NFC), WiFi (including 802.11a/b/g/n/ac or others), WiGig, Global Positioning System (GPS) networks, and other types of communications networks available at the time of the filing of this application or that may be developed in the future. Further, the network 104 may be a public network, such as the Internet, a private network, such as an intranet, or combinations thereof, and may utilize a variety of networking protocols now available or later developed including, but not limited to TCP/IP based networking protocols.

In some embodiments, the marketplace tool and/or advantage tool may be incorporated into a marketplace website that is running on the marketplace server 103. For example, the marketplace tool and/or advantage tool may be a program comprised of a set of instructions executed by a processor of the marketplace server 103. A user (e.g., buyer or seller) may utilize the marketplace tool and/or advantage tool by operating the communication device 101 or communication device 102 to access the marketplace website running the marketplace tool and/or advantage tool via the network 104. After accessing the marketplace website, the user may interact with the marketplace tool and/or advantage tool by inputting commands into the communication device 101 or 102, transmitting the commands from the communication device 101 or 102 to the marketplace website running on the marketplace server 103 via the network 104, and receiving commands and/or information from the marketplace website running on the marketplace server 103 via the network 104.

A user at the communication device 101 or communication device 102 may also communicate with each other according to the features of the marketplace tool and/or advantage tool described herein by communicating with the marketplace website running on the marketplace server 103 via the network 104. For example, a buyer operating the communication device 101 may communicate with a seller operating the communication device 102 by inputting commands, information, and/or other types of communications intended for the seller at the communication device 101, transmitting the commands, information, and/or other types of communications from the communication device 101 to the marketplace website running on the marketplace server 103 via the network 104, having the marketplace website host the commands, information, and/or other types of communication intended for the seller, and allowing the seller to access the marketplace website by having the communication device 102 communicate with the marketplace website via the network 104. By allowing the seller's communication device 102 communicate with the marketplace website, the seller may be presented with the commands, information, and/or other types of communication transmitted by the buyer for the seller. Further descriptions for the types of interaction and communication available according to the marketplace tool and/or advantage tool will be provided throughout this disclosure.

In some embodiments, the marketplace tool and/or advantage tool may be incorporated into a marketplace application running on a user operated communication device such as communication device 101 or communication device 102. According to such embodiments, the marketplace tool and/or advantage tool may be downloaded onto communication device 101 and communication device 102 as a program executed by a processor of communication device 101 and communication device 102. The marketplace tool and/or advantage tool may be transmitted to communication device 101 and communication device 102 from a remote server (e.g., the marketplace server 103), via the network 104. For example, the marketplace tool and/or advantage tool may be a program comprised of a set of instructions that are executed by the processor of communication device 101 and communication device 102, respectively, in order to accomplish one or more of the methods, features, or processes described herein. Further descriptions for the types of interaction and communication available according to the marketplace tool and/or advantage tool will be provided throughout this disclosure.

In order to achieve the methods, features, or processes described herein with respect to the capabilities of the marketplace tool and/or advantage tool, the marketplace tool and/or advantage tool may be partitioned such that part of the marketplace tool and/or advantage tool is being executed on communication device 101 or communication device 102, while another part of the marketplace tool and/or advantage tool is being executed on the marketplace server 103. It follows that a portion, or all, of the marketplace tool and/or advantage tool may be downloaded onto communication device 101 or communication device 102 such that the downloaded portion of the marketplace tool and/or advantage tool is executed on communication device 101 or communication device 102. A remaining portion of the marketplace tool and/or advantage tool may then be stored on the marketplace server 103 and executed by a processor of the marketplace server 103. The execution of both portions of the marketplace tool and/or advantage tool may allow for each respective tool to accomplish the methods, features, or processes described herein.

For example, marketplace tool and/or advantage tool may be executed on communication device 101 to receive inputs from a user. The inputs may, for example, be a question from a buyer regarding a product listed on the electronic marketplace according to this disclosure. Then, the marketplace tool and/or advantage tool may be executed on communication device 101 to transmit the user's inputs to the marketplace server 103. At the marketplace server 103, another portion of the marketplace tool and/or advantage tool may be executed to receive the user's input transmitted from communication device 101. The marketplace tool and/or advantage tool may be further executed on the marketplace server 103 to generate a display incorporating the user's inputs from communication device 101. The generated display may then be transmitted to communication device 102 for viewing by a user (e.g., seller) of communication device 102. In this way, the marketplace tool and/or advantage tool in the form of the marketplace application may facilitate communication between communication devices when the marketplace application is run, in part or in whole, on some combination of a communication device and the marketplace server 103. Further descriptions for the types of interaction and communication available according to the marketplace tool and/or advantage tool will be provided throughout this disclosure.

It is noted that the marketplace website and/or marketplace application may be presented to the user of communication device 101 or 102 according to a browser interface (e.g., web browser, application browser, or other like browser for presenting information and resources to a user of a communication device) running on the communication device 101 or 102. For example, the browser interface may be some combination of software, hardware, or middleware on the communication device 101 or 102. The browser interface may be configured to retrieve, present and traverse information from the marketplace server 103 in order to present the user with a user representation of the marketplace website or marketplace application on the respective communication device 101 or 102 according to the methods, feature and processes described herein. Such a browser interface may also be utilized on the communication device 101 or 102 to access and interact with other websites that are accessible via the network 104. Such a browser interface may also be utilized on the communication device 101 or 102 to present a user with a marketplace application run wholly on the communication device 101 or 102. In this way, the browser interface may be run on the communication device 101 or 102 in order to present a user with a user representation of the marketplace website or marketplace application as described herein.

FIGS. 2-1 to 2-3 illustrate exemplary displays for the electronic marketplace according to embodiments of this disclosure. More specifically, FIGS. 2-1 to 2-3 illustrate exemplary displays for the electronic marketplace where the marketplace tool is configured to operate with respect to a first product listing 202 that identifies a guitar for sale. The marketplace tool may be implemented as part of the electronic marketplace that may be operating in terms of the marketplace website or marketplace application, as described above.

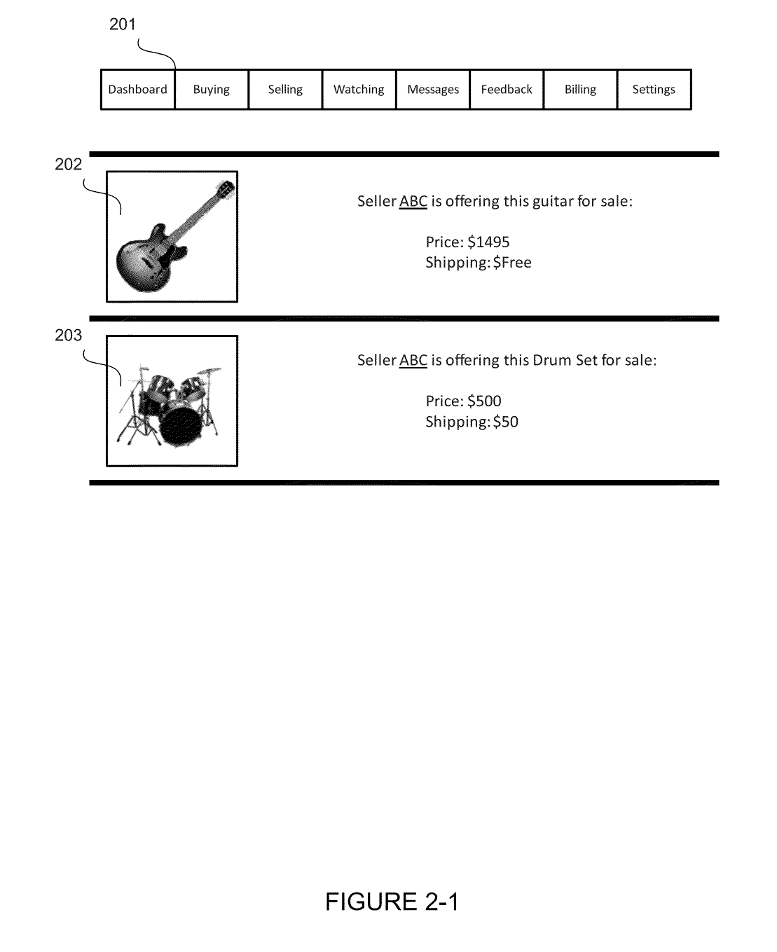

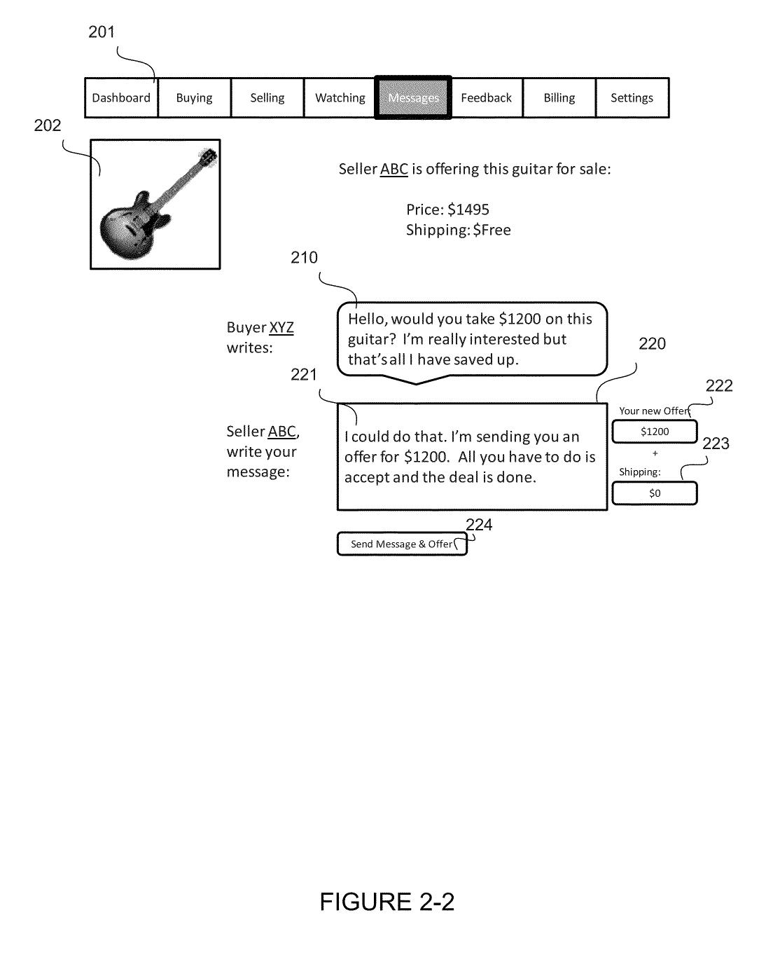

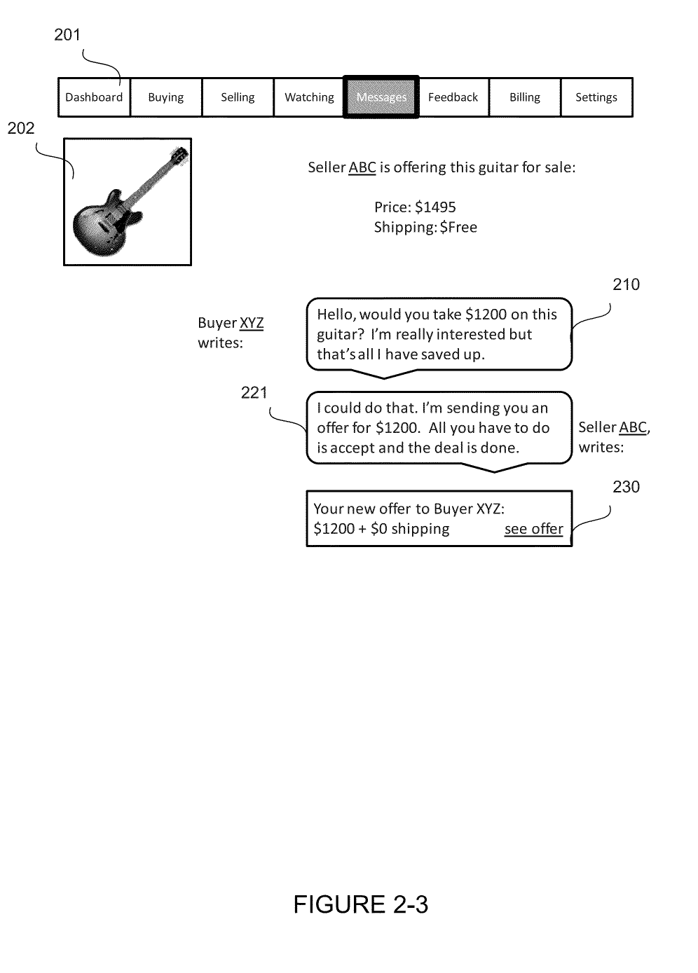

FIG. 2-1 illustrates an exemplary display for the electronic marketplace that includes a toolbar 201, first product listing 202, and second product listing 203. The toolbar 201 includes an exemplary list of toolbar options available for the electronic marketplace that includes a dashboard option, buying option, selling option, watching option, messages option, feedback option, billing option, and settings option. Each of the toolbar options of the electronic marketplace may interact with one or more features of the marketplace tool according to some embodiments. This list of toolbar options to populate the toolbar 201 is provided for exemplary purposes only, as it is within the scope of this disclosure for the toolbar 201 to include a fewer, or greater, number of options.

The dashboard toolbar option may allow a user to return to a home display screen that includes a set of uniform information designated by the marketplace tool to correspond to the user's home display screen. The user's home display screen may include a welcoming message to the user, a list of product listings being sold by the user within the electronic marketplace, a list of product listings that were viewed within a recent period of time, and a list of product listings selected by the user to be tracked. In some embodiments, the list of products being sold by the user may be included as part of a greater electronic storefront operated by the user within the electronic marketplace. In such embodiments, the user may utilize the dashboard toolbar option to operate the user's electronic storefront. For example, the user may customize the user's electronic storefront via the dashboard toolbar option by inputting new products for sale on the user's electronic storefront, inputting information describing the user's electronic storefront, and modifying a look for the user's electronic storefront (e.g., add a storefront banner for the user's electronic storefront that welcomes potential buyers within the electronic marketplace).

In addition, the list of recently viewed product listings under the dashboard toolbar option may be adjusted such that the referenced period of time may be predetermined by the electronic marketplace or adjusted by the user under the settings toolbar option. Further description of the settings toolbar option is provided below. The list of product listings that are selected by the users to be tracked may also be tracked under the watching toolbar option, where the watching toolbar option is described in further detail below. The features described as being included as part of the dashboard toolbar option are provided for exemplary purposes. It is within the scope of this disclosure that the dashboard toolbar option may include a fewer, or greater, number of features.

The buying toolbar option may allow a user to provide tools and options for allowing a user to buy products within the electronic marketplace. For example, the buying toolbar option may include a list of one or more product listings that a user has bought in the past from the electronic marketplace. The buying toolbar option may also include a list of one or more product listings that the user has bought so that the user may check on the status of the bought product (e.g., product awaiting pickup, product shipped, product in transit, product sales order cancelled, product sales transaction completed, payment pending, payment not received, payment received, payment confirmed, product out of stock, refund requested, refund completed). The buying toolbar option may also include a list of one or more product listings that the user has made an offer on, so that the user may check on the status (e.g., accepted, rejected, counter-offer, active, expired) of the offer. The buying toolbar option may also include status information (e.g., your bid was bid accepted, your bid was overbid by another user, your bid was rejected, or other possible bid status) for a list of product listings that the user has made a bid on for an auction type of sales transaction in the electronic marketplace.

When selected, the buying toolbar option may also present the user with a list of product listings available for purchase on the electronic marketplace. The buying toolbar option may also provide one or more buying tools made available to a user for assisting in the buying of a product listing on the electronic marketplace. Exemplary buying tools may include a shipping calculator that allows the user to estimate shipping costs and options for shipping a product bought on the electronic marketplace, a cross shopping tool that takes a product listing and identifies similar product listings that may be available on the electronic marketplace, a suggested product listing tool that gathers user attribute information from a user profile associated with the user in order to generate a list of suggested product listings from the electronic marketplace for the user to browse, and an advanced searching tool that allows the user to input one or more product attributes for identifying products within a product inventory of the electronic marketplace that match in whole, or part, with the one or more product attributes. The list of buying toolbar options is provided for exemplary purposes, as the electronic marketplace may include a fewer, or greater, number of buying toolbar options.

The selling toolbar option may allow a user of the electronic marketplace to sell products within the marketplace tool. For example, the selling toolbar option may include a list of one or more product listings that are offered by the user for sale on the electronic marketplace. The list of one or more product listings offered by the user for sale may additionally be sorted according to a status of the product listing (e.g., draft, live, ordered, ended, suspended, sold out). For each product listing, the selling toolbar option may, for example, include information corresponding to an asking price of the product, a category for the product, descriptive attributes of the product, a listing title, condition of the product, origin of the product, an image of the product, a product description summary of the product, and a preferred method of payment for the product. The selling toolbar option may also include a list of one or more product listings that are offered by the user for sale on an auction type sales transaction on the electronic marketplace. With regards to product offerings under the auction type sales transaction, the selling toolbar option may include status information including, but not limited to, whether a buyer's bid was accepted, overbid by another user, or rejected. The selling toolbar option may also include a list of one or more offers received by buyers within the electronic marketplace for one or more product listings offered for sale by the user within the electronic marketplace. The selling toolbar option may also include a list of one or more product listings that the user has sold so that the user may check on the status of the sold product (e.g., product awaiting pickup, product shipped, product in transit, product sales order cancelled, product sales transaction completed, payment pending, payment not received, payment received, payment confirmed, product out of stock, refund requested, refund completed).

The selling toolbar option may also include a listing tool configured to allow the user to upload one or more product listings that have been pre-populated within another electronic document. For example, the electronic document may be uploaded to the marketplace server 103 that may be running at least a part of the electronic marketplace. Then, after uploading the electronic document onto the marketplace server 103, the listing tool may parse the electronic document to identify one or more product listings included in the electronic document. The listing tool may then populate information required to list a product on the electronic marketplace with the information identified from the electronic document. The information required to list a product may include, but is not limited to, any combination of one or more of the following: an asking price of the product, a category for the product, descriptive attributes of the product, a listing title, condition of the product, origin of the product, an image of the product, a product description summary of the product, and a preferred method of payment for the product.

The watching toolbar option may allow a user to operate the electronic marketplace to track certain product listings that have been identified by a potential buyer. For example, the user may select one or more specific product listings under the watching toolbar option, the marketplace toolbar option may track the selected product listings and gather information related to the product listing, and the gathered information may be notified to the user watching the product listing. The watching toolbar option may also be configured to save a specific search inquiry/strategy input by the user, and periodically run the same search inquiry/strategy to find updated product listings that satisfy the conditions identified in the search inquiry/strategy. The results from the periodic searches on the saved search inquiry/strategy may then be notified to the user. The information identified in the results from the periodic searches may be similar, or the same, as the gathered information notified to the user based on the one or more selected product listings. Such information may include information identifying if another bid or offer has been made by another buyer on the product listing, and final sales information when the product listing has been sold. In some embodiments, the watching toolbar option may alert a user when certain predetermined triggering events occur. For example, the watching toolbar option may notify the user when an offering bid is made on a product listing identified by the user under the watching toolbar option, or when a product listing identified by the user under the watching toolbar option is sold. The watching toolbar option may notify the user according to one or more communication methods such as, for example, a push notification to a communication device (e.g., smartphone) identified within a user profile for the user, a telecommunications communications (e.g., phone call, text message), an email, mailed letter, or message through the electronic marketplace.

The watching toolbar option may also include a following tool for following one or more specific sellers within the electronic marketplace. For example, the following tool may be configured to allow the user to select one or more specific sellers on the electronic marketplace, and choose to follow them. By following the selected sellers, the following tool may present the user with update information on the seller corresponding to any changes to the seller's product inventory being offered for sale, or any promotional offerings (e.g., sales promotions) being offered by the seller. The watching toolbar option may also include a browsing history that tracks and stores product listings viewed or clicked on by the user that goes back a predetermined length of time. The predetermined length of time may be set by the watching toolbar option and may further be set and adjusted by the user.

The messages toolbar option may allow a user to operate the electronic marketplace to send or receive communications from other users within the electronic marketplace environment. For example, the messages toolbar option may allow the user to send and receive communications with other users within the electronic marketplace environment according to the marketplace tool described herein. Further description of the messaging features according to the marketplace tool is provided throughout this disclosure.

The feedback toolbar option may allow a user to operate the electronic marketplace to submit feedback messages related to specific product listings and/or sellers.

The billing toolbar option may allow a user to operate the electronic marketplace to receive billing information for one or more product listing sold and/or product listing bought by the user within the electronic marketplace. The billing toolbar option may also receive and store the user's billing information for future purchases on the electronic marketplace.

The settings toolbar option may allow a user to operate the electronic marketplace to adjust settings for the electronic marketplace and/or input user profile attribute information corresponding to the user. For example, the settings may correspond to inputting new or modifying old information related to the user's account information, electronic storefront information, payment and return policies, shipping policies, and sales tax application policies for products sold by the user.

The toolbar options described above have been provided for exemplary purposes, and are not limited to only those features described above.

FIG. 2-1 also illustrates first product listing 202 and second product listing 203. The first product listing 202 corresponds to a guitar for sale by seller ABC at a price of $1495 with free shipping. The second product listing 203 corresponds to a drum set for sale by seller ABC at a price of $500 with $50 added for shipping. The product listings are provided for exemplary purposes, as it is within the scope of this disclosure for a product listing to include a greater, or fewer, number of listing attributes. For example, in some embodiments the default product listing may include a condition (e.g., new condition, practically new condition, slightly used condition, refurbished condition) of the product in the product listing. Further, additional listing attributes may be identified when the user selects or clicks on the product listing. For example, selecting the first product listing 202 may result in the electronic marketplace presenting additional information (e.g., manufacturer of the guitar, build year of the guitar, etc.) on the guitar being offered for sale.

FIG. 2-2 illustrates an exemplary display for an implementation of the marketplace tool. The following description of the marketplace tool will be described in terms of features under the messages toolbar option. This is apparent from the highlighted messages toolbar option within the toolbar 201 at the top of the display in FIG. 2-2. However, it is within the scope of this disclosure for the marketplace tool to be implemented as a feature under any one or more of the toolbar options described above, or any one or more toolbar options not specifically described herein. For example, in some embodiments the marketplace tool may be implemented as its own standalone toolbar option.

In FIG. 2-2, buyer XYZ is shown to have sent seller ABC an inquiry communication 210 in terms of the first product listing 202 offered for sale by seller ABC. In this way, the marketplace tool is seen to facilitate buyer XYZ initiating communication with seller ABC. The inquiry communication 210 may be related to the first product listing 202, and may additionally include a new offer by the buyer XYZ for purchasing the guitar identified in the first product listing 202. For example, the inquiry communication 210 illustrated in FIG. 2-2 writes, “Hello, would you take $1200 on this guitar? I'm really interested but that's all I have saved up.”

Although the inquiry communication 210 is illustrated to include a new purchase price offer from buyer XYZ, in other embodiments the inquiry communication 210 may not include a new purchase price offer, and instead include inquiries from buyer XYZ related to the guitar product identified in the first product listing 202. A new purchase price offer from buyer XYZ may be submitted in a later inquiry communication from buyer XYZ to seller ABC.

In addition or alternatively, the inquiry communication 210 sent by buyer XYZ to seller ABC may be kept private for viewing only by the seller ABC. In other words, the conversation including the inquiry communication 210 and any response from the user (i.e., seller ABC) back to the buyer XYZ may not be viewable to other users of the electronic marketplace. This privacy level may be attained by requiring seller ABC to be certified before allowing seller ABC to view the inquiry communication 210. For example, the marketplace tool may include an authentication feature where seller ABC is required to input certification information that must satisfy one or more certification requirements before seller ABC is allowed to be presented with the inquiry communication 210. The certification requirements may be a passcode check where the seller ABC is required to input a valid passcode that matches a passcode on file with the marketplace tool as part of seller ABC's user profile before seller ABC is allowed access to view the inquiry communication 210 from buyer XYZ. This specific authentication feature is provided for exemplary purposes, as it is within the scope of the present disclosure for the marketplace tool to include other types of authentication feature. For example, the authentication feature may be a biometric authentication that requires the marketplace tool to scan a biometric attribute (e.g., fingerprint, facial recognition, palm print, hand geometry, iris recognition, retina scan, voice recognition, etc.) of seller ABC, compare the scanned biometric with corresponding biometric information stored with the marketplace tool as part of seller ABC's user profile, and allow seller ABC to access and be presented with the inquiry communication 210 from buyer XYZ when the scanned biometric satisfies the corresponding biometric information stored with the marketplace tool as part of seller ABC's user profile. In some embodiments, the authentication feature may be a combination of one or more of the exemplary authentication features described above. In some embodiments, the authentication feature may be applied to buyer XYZ in addition to seller ABC as described above.

After satisfying the authentication feature included in some embodiments of the marketplace tool, seller ABC may be presented with buyer XYZ's inquiry communication 210. In order to respond to buyer XYZ's inquiry communication 210, the marketplace tool may include a response box 220 for seller ABC to type in a response communication 221. The marketplace tool may additionally include a new price offer box 222 and new shipping rate box 223 for seller ABC to include new purchase offers and new shipping rates for the first product listing 202. For example, seller ABC's new response communication 221 may write, “I could do that. I'm sending you an offer for $1200. All you have to do is accept and the deal is done.” The new purchase price offer of $1200 for the first product listing 202 may have been typed into the response box 220 to be part of the response communication 221 by seller ABC.

Alternatively, in some embodiments the response communication 221 may have been automatically populated with the new purchase price and shipping information input into the new price offer box 222 and new shipping rate box 223, respectively. For example, instead of the user typing out the response communication 221 into the response box 220, the marketplace tool may be configured to generate some, or all, of the response message 221. The marketplace tool may accomplish this feature by identifying the new price offer typed into the new price offer box 222 and the new shipping rate typed into the new shipping rate box 223, and generating an automated response communication to include the new price offer (e.g. $1200) and the new shipping rate (e.g., $0, which is consistent with the free shipping identified in the original purchase price offer for the first product listing, but a new shipping rate typed into the new shipping rate box 223 may be populated into the automated response communication).

The automated response communication including the new price offer and new shipping rate may be generated based on a triggering event. For example, the triggering event may be seller ABC filling in new values into the new price offer box 222 and new shipping rate box 223. According to another example, the triggering event may be seller ABC filling in new values into the new price offer box 222 and new shipping rate box 223 and then selecting (e.g., clicking) the new price offer box 222 and/or selecting new shipping rate box 223, thus indicating the inputted values are to be referenced in the generation of the automated communication.

After the response communication 221 is generated according to any of the methods described above, seller ABC may send the response communication to buyer XYZ by selecting the send button 224. By selecting the send button 224, the response communication 221 that includes the response to buyer XYZ's inquiry communication 210 and the new purchase price offer (e.g., reduced price of $1200 for the guitar and the same free shipping) may be sent to buyer XYZ.

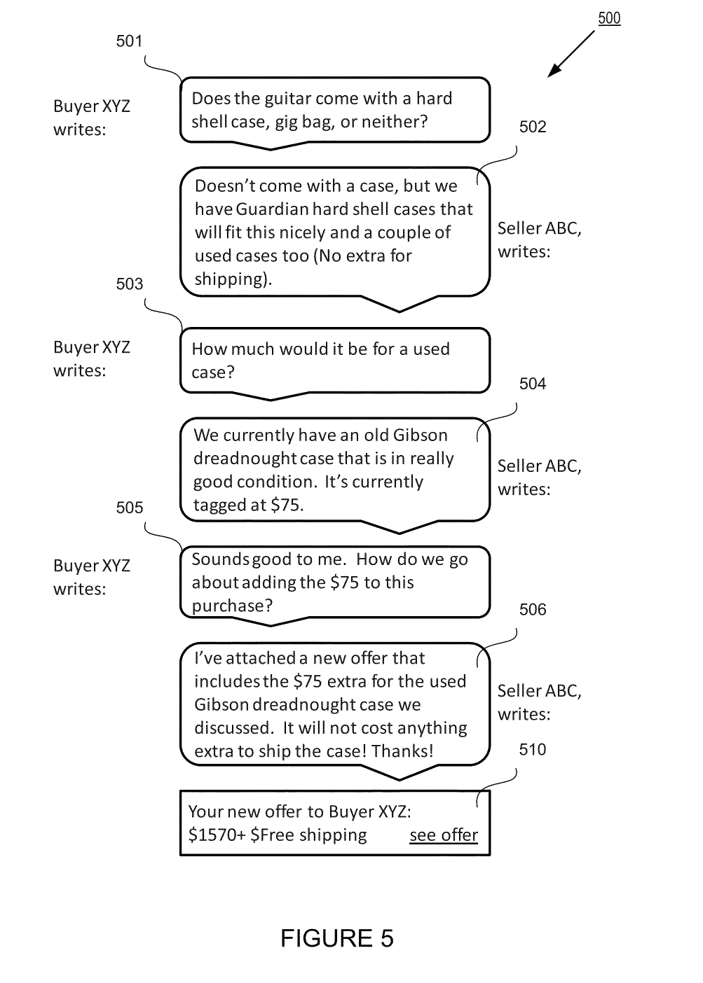

In other embodiments, the response communication 221 may not include a new purchase price offer, and instead include responses to inquiries from buyer XYZ related to the guitar product identified in the first product listing 202. A new purchase price offer from the seller ABC may be submitted in a latter response communication from the seller ABC to the buyer XYZ. For example, FIG. 5 illustrates an embodiment where a new purchase price offer is not submitted until multiple rounds of communications between buyer XYZ and seller ABC. Further description of an implementation of the marketplace tool according to the features illustrated in FIG. 5 is provided later in this disclosure.

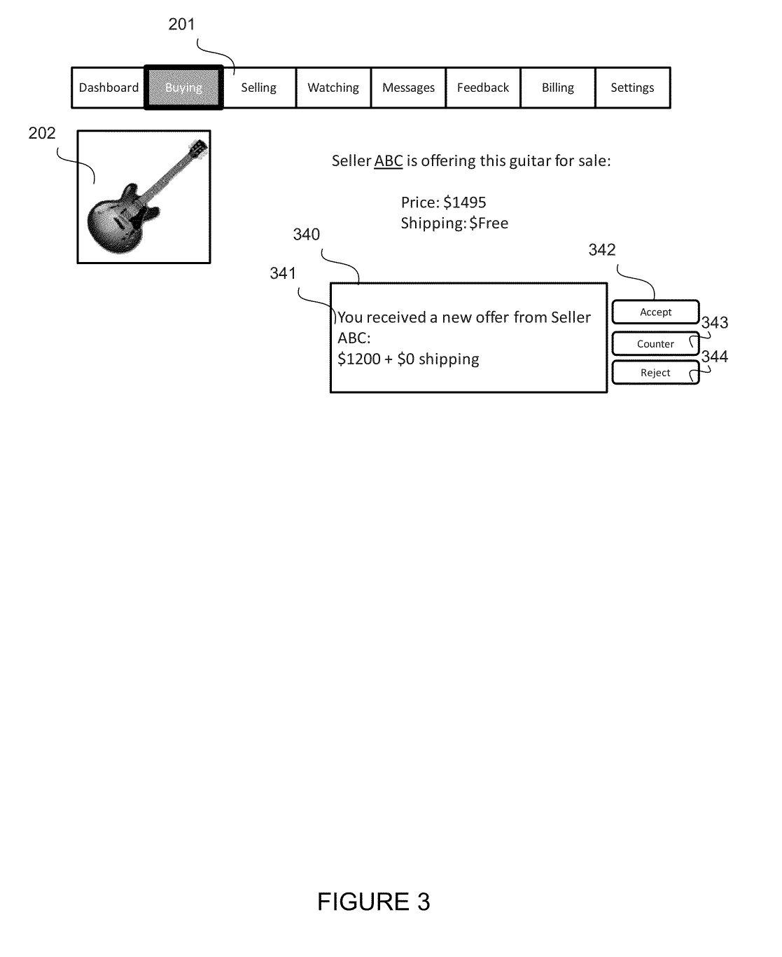

FIG. 2-3 illustrates an exemplary display for an implementation of the marketplace tool. After sending the response communication 221 to buyer XYZ, seller ABC may optionally be presented with an official offer box 230 that includes the new terms of the new price offer included in seller ABC's response communication 221. The official offer box 230 may identify the terms of the new purchase offer included in the response communication 221, which includes revised purchase price information (e.g., $1200) and revised shipping rate information. The official offer box 230 may also include a link (e.g., “see offer”), that when selected (e.g., clicked on) will take the user to the full terms of the new sales conditions.

It should be noted that although the shipping rate was not revised in the exemplary situation illustrated in FIGS. 2-1 to 2-3, it is within the scope of the present disclosure for the shipping rate to have been revised in the response communication 221 from seller ABC.

FIG. 3 illustrates an exemplary display for an implementation of the marketplace tool from the viewpoint of a buyer, for example buyer XYZ. The following description of the marketplace tool within the context of the display illustrated in FIG. 3 will be described in terms of features under the buying toolbar option. This is apparent from the highlighted buying toolbar option within the toolbar 201 at the top of the display in FIG. 2-2. However, it is within the scope of this disclosure for the marketplace tool to be implemented as a feature under any one or more of the toolbar options described above, or any one or more toolbar options not specifically described herein. For example, in some embodiments the exemplary display illustrated in FIG. 3 may be included as part of the messaging toolbar option. It should also be noted that in some embodiments, buyer XYZ may be required to be certified under the same authentication feature described above with reference to seller ABC. In this way, buyer XYZ may be similarly required to pass an authentication feature that certifies the buyer's identify based on information stored within a user profile corresponding to buyer XYZ before the exemplary display illustrated in FIG. 3 is presented to buyer XYZ.

After satisfying the authentication feature included in some embodiments of the marketplace tool, buyer XYZ may be presented with the exemplary display illustrated in FIG. 3. The exemplary display illustrated in FIG. 3 includes the same first purchase listing 202 and toolbar 201, however in this exemplary display the buying toolbar option is highlighted, thus indicating the marketing tool is being implemented under the features of the buying toolbar option. The exemplary display additionally includes a communication box 340 that includes within it an offer communication 341 from seller ABC. In this case, the offer communication 341 corresponds to the new price offer included in the response communication 221 previously described as being sent to buyer XYZ by seller ABC.

The exemplary display also includes response options that may be selected by buyer XYZ to respond to the new purchase price offer identified in the offer communication 341. The response options include an accept response 342, a counter response 343, and a reject response 344. By selecting one of the response options, buyer XYZ may transmit a response to seller ABC's new purchase price offer. For example, by selecting the accept response 342, the buyer XYZ may effectively accept the new purchase price offer. By selecting the counter response 343, the buyer XYZ may input additional terms outlining a counter offer to the seller ABC's new purchase price offer for the first purchase listing 202. By selecting the reject response 344, the buyer XYZ may effectively reject the seller ABC's new purchase price offer. In any one of these cases, the marketplace tool may operate to effectively respond to seller ABC's new purchase price offer, and in some embodiments the response may be automatically sent to seller ABC based on the selection of one of the accept response 342, the counter response 343, or the reject response 344.

FIGS. 4-1 to 4-2 illustrate exemplary displays for the electronic marketplace according to embodiments of this disclosure. More specifically, FIGS. 4-1 to 4-2 illustrate exemplary displays for the marketplace tool in terms of the second product listing 203 that identifies a drum set for sale. The marketplace tool may be implemented as part of the electronic marketplace that may be operating in terms of the marketplace website or marketplace application, as described above.

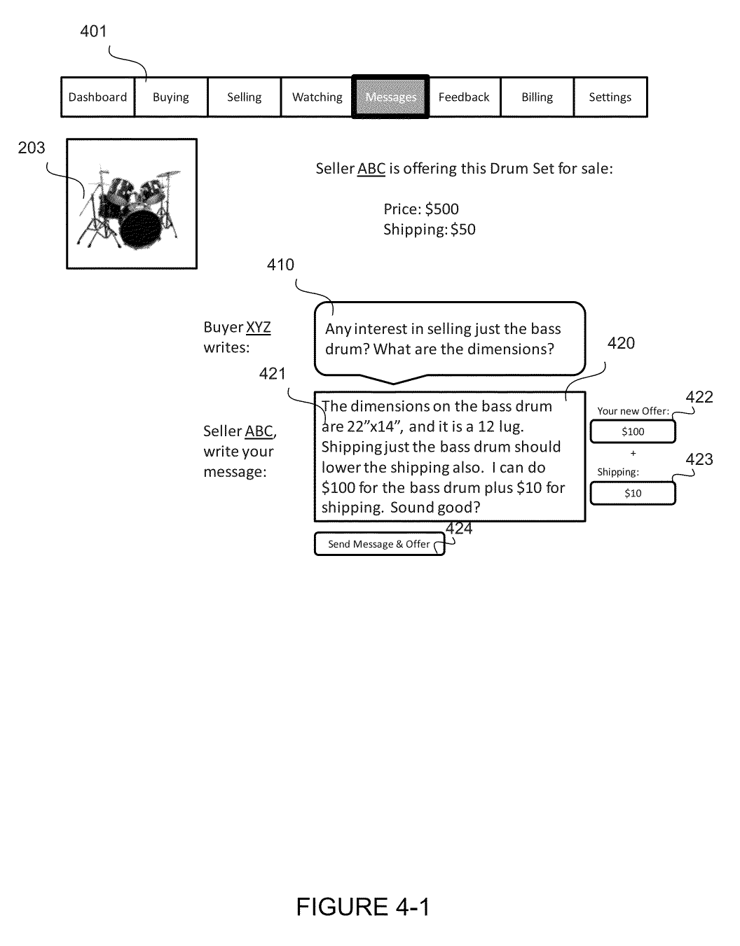

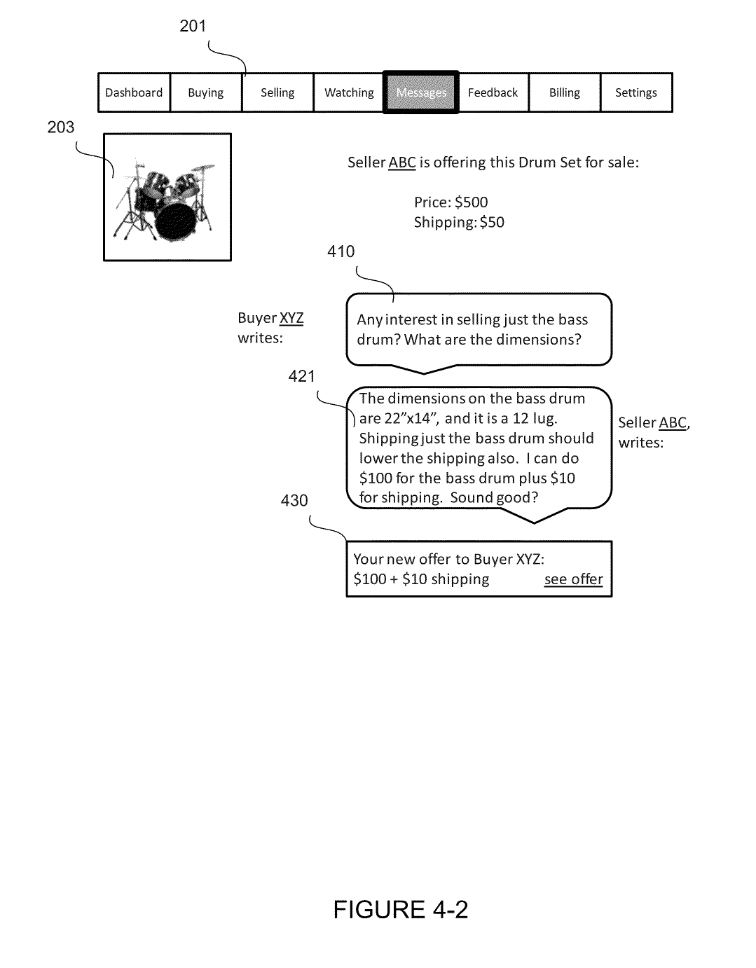

The exemplary display in FIG. 4-1 includes a toolbar 401, where the toolbar 401 may be the same as the toolbar 201 described above. In addition, FIG. 4-1 illustrates buyer XYZ as having sent seller ABC an inquiry communication 410 in terms of the second product listing 203 offered for sale by the seller ABC. In this way, the marketplace tool is seen to facilitate buyer XYZ initiating communication with seller ABC. The inquiry communication 410 writes, “Any interest in selling just the bass drum? What are the dimensions?” The inquiry communication 410 may be related to the second product listing 203, as illustrated in FIG. 4-1. Although the inquiry communication 410 is illustrated as not including a new purchase price offer from the buyer XYZ, in other embodiments the inquiry communication 410 may additionally include a new offer by the buyer XYZ for purchasing the drum set, or parts thereof, identified in the second product listing 203. A new purchase price offer from the buyer XYZ or seller ABC may also be submitted in a later communication.

In addition or alternatively, the inquiry communication 410 sent by buyer XYZ to seller ABC may be kept private for viewing only by seller ABC. In other words, the conversation including the inquiry communication 410 and any response from the user (i.e., seller ABC) back to buyer XYZ may not be viewable to other users of the electronic marketplace. This privacy level may be attained by requiring seller ABC to be certified before allowing the seller ABC to view the inquiry communication 410. For example, the marketplace tool may include an authentication feature where the seller ABC is required to input certification information that must satisfy one or more certification requirements before the seller ABC is allowed to be presented with the inquiry communication 410. The authentication feature may be in accordance to any one or more of the authentication feature described above.

After satisfying the authentication feature included in some embodiments of the marketplace tool, seller ABC may be presented with buyer XYZ's inquiry communication 410. In order to respond to buyer XYZ's inquiry communication 410, the marketplace tool may include a response box 420 for seller ABC to type in a response communication 421. The marketplace tool may additionally include a new price offer box 422 and new shipping rate box 423 for seller ABC to include new purchase offers and new shipping rates for the second product listing 203. For example, seller ABC's new response communication 421 may write, “The dimensions on the bass drum are 22″×14″, and it is a 12 lug. Shipping just the bass drum should lower the shipping also. I can do $100 for the bass drum plus $10 for shipping. Sound good?” The new purchase price offer of $100 is revised from the original $500 for the second product listing 203 in order to correspond to only the bass drum portion of the drum set inquired in the inquiry communication 410. Similarly, the new shipping rate price of $10 is revised from the original $50 quote in order to reflect the lighter shipping load for only the bass drum portion of the drum set. In this way, both the purchase price offer and the shipping rate quote may be revised in seller ABC's response communication 421.

In some embodiments the new purchase price offer of $100 for the revised second product listing 203 (i.e., just the bass drum from the entire drum set) may have been typed into the response communication 421 by seller ABC.

Alternatively, in some embodiments the response communication 421 may have been automatically populated with the new purchase price and shipping information input into the new price offer box 422 and new shipping rate box 423, respectively. For example, instead of typing out the new purchase price conditions into the response communication 421 typed into response box 420, the marketplace tool may be configured to identify the new price offer typed into the new price offer box 422 and the new shipping rate typed into the new shipping rate box 423, and generate an automated response communication to include the new price offer (e.g. $100) and the new shipping rate (e.g., $10). The automated response communication including the new price offer and new shipping rate may be generated based on a triggering event. For example, the triggering event may be seller ABC filling in new values into the new price offer box 422 and new shipping rate box 423. According to another example, the triggering event may be seller ABC filling in new values into the new price offer box 422 and new shipping rate box 423 and then selecting (e.g., clicking) the new price offer box 422 and/or selecting new shipping rate box 423, thus indicating the inputted values are to be referenced in the generation of the automated communication.

After the response communication 421 is generated according to any of the methods described above, seller ABC may send the response communication to buyer XYZ by selecting the send button 424. By selecting the send button 424, the response communication 421 that includes the response to buyer XYZ's inquiry communication 410 and the new purchase price offer (e.g., $100 for just the bass drum and $10 more for shipping) may be sent to buyer XYZ. In other embodiments, the response communication 421 may not include a new purchase price offer, and instead include responses to inquiries from buyer XYZ related to the guitar product identified in the second product listing 203. A new purchase price offer from the seller ABC may be submitted in a latter response communication from the seller ABC to the buyer XYZ. For example, FIG. 5 illustrates an embodiment where a new purchase price offer is not submitted until multiple rounds of communications between buyer XYZ and seller ABC. Further description of an implementation of the marketplace tool according to the features illustrated in FIG. 5 is provided later in this disclosure.

FIG. 4-2 illustrates an exemplary display for an implementation of the marketplace tool. After sending the response communication 421 to buyer XYZ, seller ABC may optionally be presented with an official offer box 430 that includes the new terms of the new price offer included in seller ABC's response communication 421. The official offer box may identify the terms of the new purchase offer included in the response communication 421, which includes revised purchase price information (e.g., $100 for just the bass drum) and revised shipping rate information (e.g., reduced to $10 for the lighter load of just the bass drum). The official offer box 430 may also include a link (e.g., “see offer”), that when selected (e.g., clicked on) will take the user to the full terms of the new sales conditions.

Although not specifically illustrated, buyer XYZ may then be presented with the seller ABC's response communication 421, in a similar, or same, manner as described with reference to the presentation of seller ABC's response communication 221 in the exemplary display illustrated in FIG. 3 above. For example, an exemplary buyer display may include an accept response, a counter response, and a reject response. By selecting one of the response options, buyer XYZ may transmit a response to seller ABC's new purchase price offer. For example, by selecting the accept response, buyer XYZ may effectively accept the new purchase price offer. By selecting the counter response, buyer XYZ may input additional terms outlining a counter offer to seller ABC's new purchase price offer for the second purchase listing 203. By selecting the reject response, buyer XYZ may effectively reject seller ABC's new purchase price offer. In any one of these cases, the marketplace tool may operate to effectively respond to seller ABC's new purchase price offer, and in some embodiments the response may be automatically sent to seller ABC based on the selection of one of the accept response, the counter response, or the reject response.

FIG. 5 illustrates a communication set 500 that includes one or more inquiry communications from a first user (e.g., buyer XYZ) of the electronic marketplace and one or more response communications from a second user (e.g., seller ABC) of the electronic marketplace. The communication set 500 is an implementation of the marketplace tool described according to an aspect of this disclosure. For example, the communication set 500 may be implemented by the marketplace tool as a live chat session according to some embodiments. In other embodiments, the communication set 500 may be implemented by the marketplace tool as a series of communications being sent and received into user mailboxes, as described above with reference to FIGS. 2-1 to 2-3 and FIGS. 4-1 to 4-2.

Further, unlike the exemplary displays illustrated in FIGS. 2-1 to 2-3 and FIGS. 4-1 to 4-2, the communication set 500 includes multiple inquiry communications from the buyer XYZ and response communications from the seller ABC. The new purchase price for the product being discussed is not disclosed until later in the communication set, thus allowing the marketplace tool to facilitate a natural correspondence between buyer XYZ and seller ABC. The more natural correspondence allows for the marketplace tool to offer, in some instances, a more complete shopping experience for a user who is buying, or selling, products on the electronic marketplace. The more natural correspondence may also allow the marketplace tool to offer, in some instances, a better merchant experience for the user who is selling products on the electronic marketplace.

The product listing being discussed here may be, for example, the first product listing 202 by seller ABC that is offering the guitar priced at $1495 and includes free shipping. Buyer XYZ initiates the communication by sending a first inquiry communication 501 to seller ABC inquiring whether the guitar comes with a hard shell case, a gig bag, or neither. In response, seller ABC sends a first response communication 502 back to the buyer XYZ that notifies buyer XYZ that the price for the guitar does not include any case. However, the first response communication 502 does let buyer XYZ know that seller ABC carries hard cases that can also be sold and wouldn't cost anything extra to ship. Based on this response, buyer XYZ writes a second inquiry communication 503 asking how much a used hard case sold by seller ABC would cost. Seller ABC then writes a second respond communication 504 identifying a specific used hard case being sold, as well as the cost of $75 for the specific used hard case. Buyer XYZ then writes a third inquiry communication 505 that indicates buyer XYZ is interested in also buying the used hard case identified by seller ABC, and inquires how the new purchase terms can be finalized for purchase of both the guitar and used hard case. Seller ABC responds by sending a third response communication 506 that notifies buyer XYZ that the seller ABC will attach a new offer that includes the addition of the hard guitar case for $75 on top of the guitar priced at $1495, for a final price of $1570 and free shipping. The final sales offer from the seller ABC may be presented to the buyer XYZ in an offer box 510 as illustrated in FIG. 5. The offer box 510 may also include a link (e.g., “see offer”), that when selected (e.g., clicked on) will take the user to the full terms of the new sales conditions.

The description of flow chart 500 is provided as an exemplary process implemented by the marketplace tool. It is within the scope of the innovation described by this disclosure to include fewer, or greater, steps than those specifically described within flow chart 500.

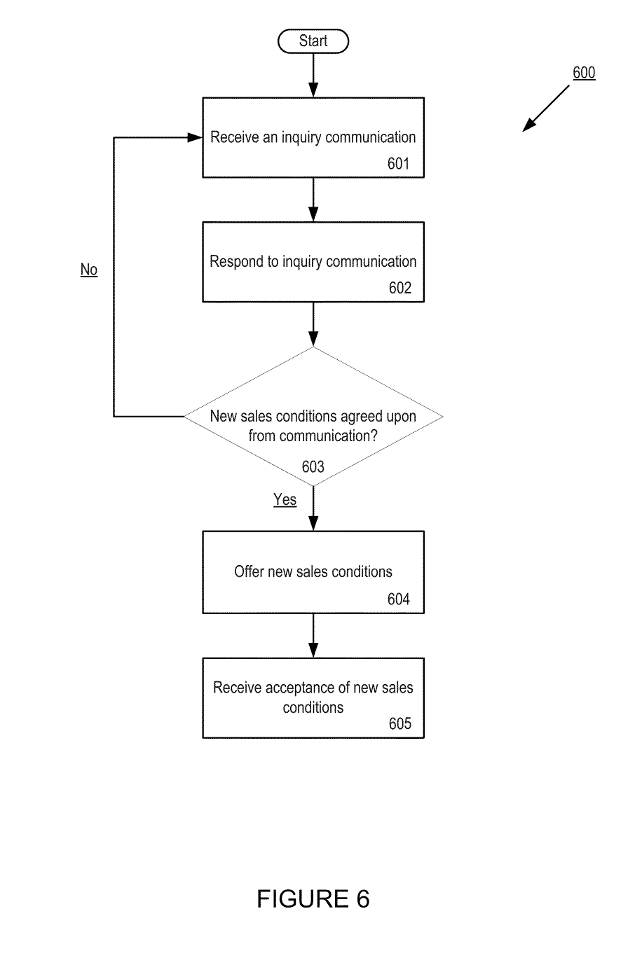

FIG. 6 illustrates a flow chart 600 that describes a process according to an implementation of the marketplace tool as described in this disclosure. The marketplace tool is configured to allow users within the electronic marketplace to communicate in an effort to promote a better customer and merchant experience for users that are buyers and sellers, respectively, on the electronic marketplace.

At 601, a user that is a seller on the electronic marketplace may receive an inquiry communication from a user that is a buyer, or potential buyer, on the electronic marketplace. The inquiry communication may be received by the seller according to any one or more of the methods described above with reference to the receipt of an inquiry communication from a buyer.

At 602, the seller may respond to the inquiry communication received at 601 by sending a response communication to the buyer. The response communication may be sent back to the buyer according to any one or more of the methods described above with reference to sending a response communication back to a buyer.

At 603, a determination is made by the marketplace tool as to whether new sales conditions or terms have been agreed upon from the previous communications between the seller and buyer. If the marketplace tool determines that new sales conditions or terms have been agreed upon based on an analysis of one or more of the previous communications between the seller and buyer, the marketplace tool may further the process to 604. If the marketplace tool determines that new sales conditions or terms have not been agreed upon based on the analysis of the previous communications between the seller and buyer, the marketplace tool may go back to allowing the seller and buyer to communicate further at 601 (or alternatively at 602).

At 604, the new sales conditions or terms are offered in an official capacity by the seller to the buyer. This offering of the new sales conditions or terms may be in accordance to any one or more of the methods described above with reference to offering new sales conditions or terms.

At 605, the buyer may send, and the seller may receive, an acceptance of the new sales conditions or terms previously offered at 604. The acceptance of the new sales conditions or terms may be in accordance to one or more of the methods described above with reference to accepting new sales conditions or terms. In addition or alternatively, instead of an acceptance of the new sales conditions or terms, at 605 the buyer may send, and the seller may receive, a counter offer or rejection as described above.

The process described by flow chart 600 is provided for exemplary purposes only. For instance, it is within the scope of the innovation described in this disclosure for the marketplace tool to include fewer, or more, steps than the process described by flow chart 600.

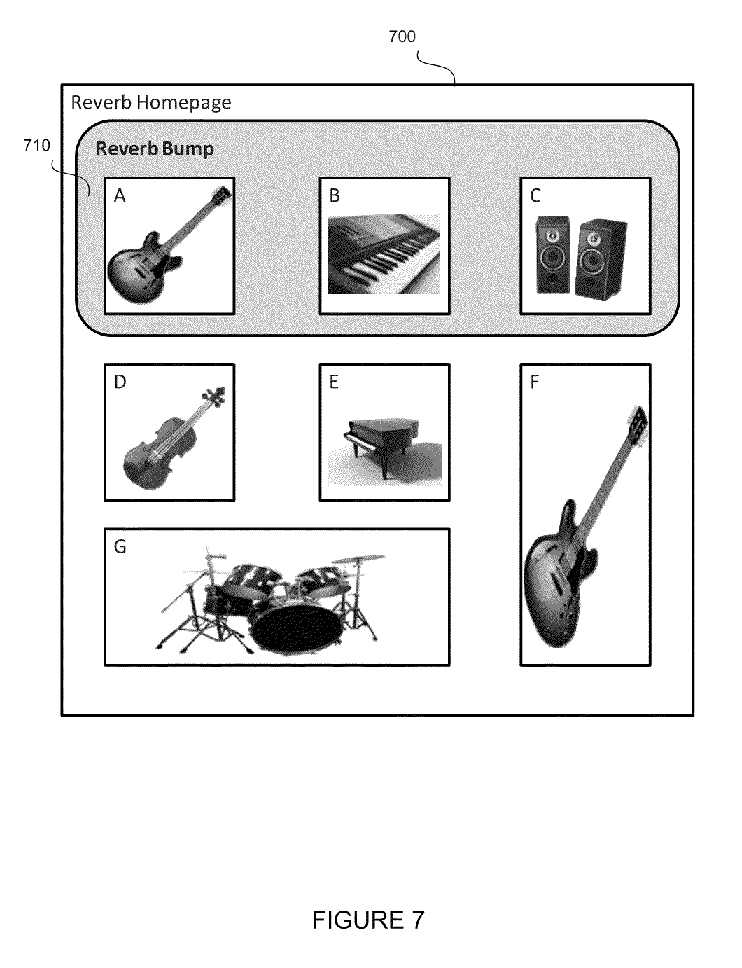

FIG. 7 illustrates an exemplary display for an implementation of the advantage tool according to some embodiments. As with the marketplace tool, the advantage tool may be implemented on the electronic marketplace operating in terms of the marketplace website or marketplace application, as described above.

Specifically, FIG. 7 illustrates an overall main display 700 (e.g., Reverb Homepage), and a sub-display 710 (Reverb Bump) within the main display 700. The main display 700 includes a first product listing for product D (e.g., violin), a second product listing for product E (e.g., piano), a third product listing for product F (e.g., guitar), and a fourth product listing for product G (e.g., drum set).

As illustrated in FIG. 7, the size and/or shape of the product listings in the main display 700 may be different. For example, in some embodiments the electronic marketplace may categorize product listings based on the offered price of the product listing. In such embodiments, for example, a more expensive product listing may have a larger size than a product listing that is less expensive. Conversely, a more expensive product listing may have a smaller size than a product listing that is less expensive. As another example, the electronic marketplace may organize product listings into set price ranges, and then assign specific product listing sizes or shapes based on the corresponding price range of the product listing.

In addition or alternatively, in some embodiments the electronic marketplace may categorize product listings based on the product type. Some exemplary products types may include, but are not limited to, musical instruments, clothing, services, and equipment. Further sub-product types may be string instruments, percussion instruments, woodwind instruments, keyboard instruments, musical lessons, musical performances, instrument repair services, electronic equipment, and the like. After categorizing each product listing into a product type, and/or a sub-product type, the electronic marketplace may assign a specific product listing size or shape based on the corresponding product listing type and/or sub-product type assigned to the product listing. For example, the electronic marketplace may learn that certain product types (e.g., drums and guitars) are more popular than other types of products (e.g., violins and pianos). Then based on this understanding, the electronic marketplace may assign larger product listing sizes or shapes to those products that belong to more popular product types and/or sub-product types, while assigning smaller product listing sizes or shapes to those products that belong to less popular product types and/or sub-product types. The converse may also be true, where in an effort to better promote less popular product types, the electronic marketplace may assign larger product listing sizes or shapes to those products that belong to less popular product types and/or sub-product types, while assigning smaller product listing sizes or shapes to those products that belong to more popular product types and/or sub-product types.

The determination of whether a product type is considered to be popular may be based on a rate (e.g., number of products sold within a set time period) at which products within a product type are sold, a number of days within which products within a product type are sold from the date the product is put on the electronic marketplace, a total number of products sold within a set time period (e.g., day, week, month, date, or other measurable time period), a number of times a product type was searched for, or some other measure of popularity. In this way, product types that sold at or above a predetermined rate, sold on average within a predetermined number of days, sold above a predetermined number of units, or was searched more than a predetermined number of times, may be considered by the electronic marketplace to be popular.

In addition or alternatively, the size or shape of a product listing may be determined by whether a seller paid for a larger product listing size or shape. For example, the advantage tool may allow a seller to pay for their product listing to be a larger size or shape in order to be more recognizable within the main display 700 and/or sub-display 710. The advantage tool may increase the size or shape of a product listing from a default size or shape based on how much the seller has paid for such advantage. In other words, the advantage tool may be configured to increase the size or shape of the product listing in direct correlation to an amount extra paid by the seller of the product listing for such advantage.

The exemplary display illustrated in FIG. 7 also includes the sub-display 710 portion, where the sub-display 710 is visually distinct from the main display 700. For example, the sub-display may have a background color, pattern, or image that is different from the main display 700. The sub-display 710 includes a first product listing for product A (e.g., guitar), a second product listing for product B (e.g., keyboard), and a third product listing for product C (e.g., speakers). In some embodiments, as illustrated in FIG. 7, the number of product listings in the sub-display 710 may be less than the number of product listings in the main display 700. In other embodiments, the number of product listings in the sub-display 710 may be the same, or more, than the number of product listings in the main display 700. Also, the advantage tool will ensure that the sub-display 710 will be located at a prominent location on the overall display. For example, the advantage tool may be configured to place the sub-display 710 at the top of the overall display, or along one of the left or right edges, in order to ensure the product listing within the sub-display 710 will be viewed by users of the electronic marketplace.

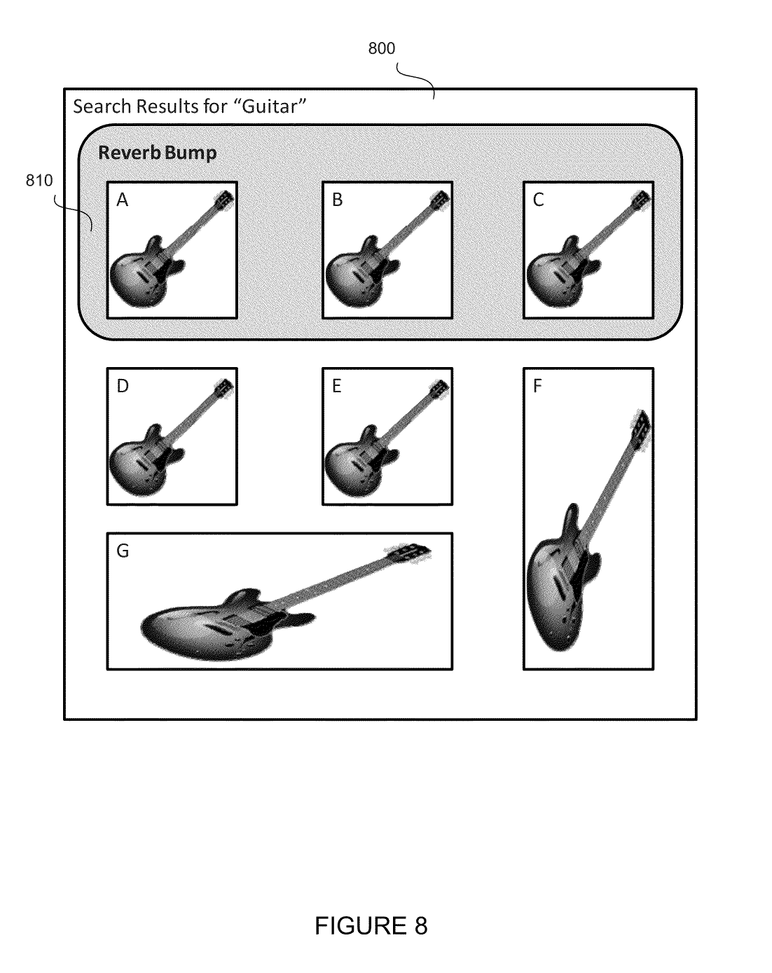

While the exemplary display illustrated in FIG. 7 may correspond to a general display for product listings as generated by the advantage tool, FIG. 8 illustrates a more concentrated exemplary display that may have been generated based on a search command input by a user to search for a “Guitar” within the inventory of the electronic marketplace. In the exemplary display illustrated in FIG. 8, there is still a main display 800 and a sub-display 810. The main display is comprised of first product listing for guitar product D, second product listing for guitar product E, third product listing for guitar product F, and fourth product listing for guitar product G. The size and/or shape of each product listing in the main display 800 may have been determined based on one or more of the methods described throughout this disclosure.

FIG. 8 also illustrates the sub-display 810 populated with different guitar product listings. For instance, sub-display 810 includes a first product listing for guitar product A, a second product listing for guitar product B, and a third product listing for guitar product C. The size and/or shape of each product listing in the sub-display 810 may have been determined based on one or more of the methods described throughout this disclosure. In this way, the advantage tool is capable of populating a sub-display with general product listings as provided in sub-display 710, or with specified product types as illustrated in sub-display 810 that is the result of a product type specific search inquiry input by a user.

The product listings that are included within sub-display 710, sub-display 810, or in any other sub-display according to other embodiments of the advantage tool, may represent a portion of an overall product inventory for products available for sale on the electronic marketplace. In order to determine which product listings from the electronic marketplace inventory of product listings will be included in a sub-display, the advantage tool is configured to parse through the electronic marketplace inventory and identify product listings with bump values. Product listings that have a remaining bump value may then be considered by the advantage tool for inclusion in the sub-display. A seller may add bump value for their product listing by payment. Further description for how bump values may be accumulated for a product listing and how the advantage tool promotes product listings with bump values is provided below.

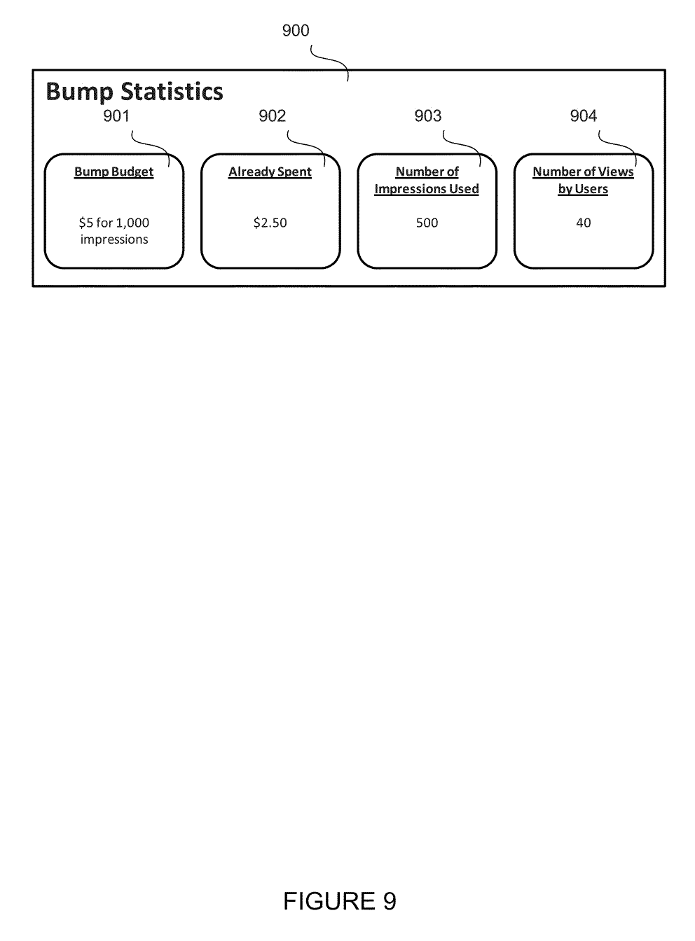

FIG. 9 illustrates an exemplary statistical table 900 that includes information for the implementation of the advantage tool for a specified product listing being sold by a seller on the electronic marketplace. Specifically, the statistical table 900 includes a budget tab 901 for tracking an amount of bump values bought by a seller for the specified product listing, a budget spent tab 902 for tracking an ongoing amount spent on bump values for the specified product listing, an impressions tab 903 that tracks a number of bump impressions presented to users for the specified product listing, and a views tab 904 that tracks a number of views by users for the specified product listing.

The seller for the specified product listing may interact with the advantage tool running as part of the electronic marketplace, and purchase an original amount of bump value from the advantage tool. For example, the statistical table 900 identifies the seller as having bought 1,000 bump impressions for $5. The bump impressions correspond to an instance of the product listing being selected by the advantage tool to be displayed within the sub-display of the electronic marketplace. So for $5, the seller has purchased the right to be selected by the advantage tool for inclusion in the sub-display.

The spent tab 902 keeps track of the remaining bump value for the product listing in terms of a monetary amount. For example, the statistical table 900 identifies that of the original $5 paid for the 1,000 bump impressions (i.e., bump value), 500 bump impressions have already been promoted by the advantage tool for the product listing. Therefore the seller is left with 500 bump impressions remaining, which corresponds to $2.50 in monetary value. Directly related to the spent tab 902 is the impressions tab 903. The impressions tab 903 identifies a number of bump impressions remaining from the originally purchased value. So for the remaining $2.50 in monetary value, the seller is left with 500 bump impressions for the advantage tool to select the seller's product listing for inclusion in the sub-display. In some embodiments the monetary value of remaining bump impressions as identified in the spent tab 902 may be understood to be the bump value for the product listing. In other embodiments the number of bump impressions remaining as identified in the impressions tab 903 may be understood to be the bump value for the product listing.

The advantage tool may also keep track of a number of times the product listing is viewed. This value is identified in the views tab 904 included in the statistical table 900. A product listing may be considered by the advantage tool to be viewed if the product listing is selected by a user. For example, the user may select a product listing by clicking over an area on a display interface of the electronic marketplace that corresponds to the product listing. The clicking input may be accomplished with an input command device such as a mouse, trackpad, or touchscreen interface. The product listing view is differentiated from a bump impression in that the advantage tool identifies a product listing view based on a user's selection of the product listing, where the product listing may be included in the main display or sub-display. In contrast, the advantage tool identifies a bump impression whenever the product listing is selected to be displayed within the sub-display. For example, a bump impression may be understood to be used up by the advantage tool when the product listing is selected to be included in the sub-display for an instance of a user accessing the electronic marketplace and being presented with a display of the electronic marketplace. In this way, the counting of the bump impression is enacted by the advantage tool when the product listing is displayed within the sub-display, and does not require a user to actually select the product listing while it is displayed within the sub-display.

The statistical table 900 is provide for exemplary purposes only, as it is within the scope of the innovation described in this disclosure for the advantage tool to utilize a statistical table 900 that includes a greater, or fewer, number of tabs for tracking the bump value of the product listing.

Further, while in some embodiments the advantage tool may require the user to purchase the bump impressions when ordering the bump impressions, it is also within the scope of this disclosure for the advantage tool to delay payment of the bump impressions until the corresponding product listing sells. In this way, the advantage tool may not charge the seller for implementing the advantageous bump impressions for the product listing until the product listing sells. And in those instances where the product listing does not sell, the seller may not have to pay for the bump impressions enjoyed by the product listing. In addition, in some embodiments, the advantage tool may only charge the seller for the number of bump impressions used before the product listing was sold. Such features of the advantage tool may limit the financial risk for the seller, and serve to convince the seller to utilize the bump impression feature of the advantage tool. Further description of this feature of the advantage tool will be provided in further detail below.

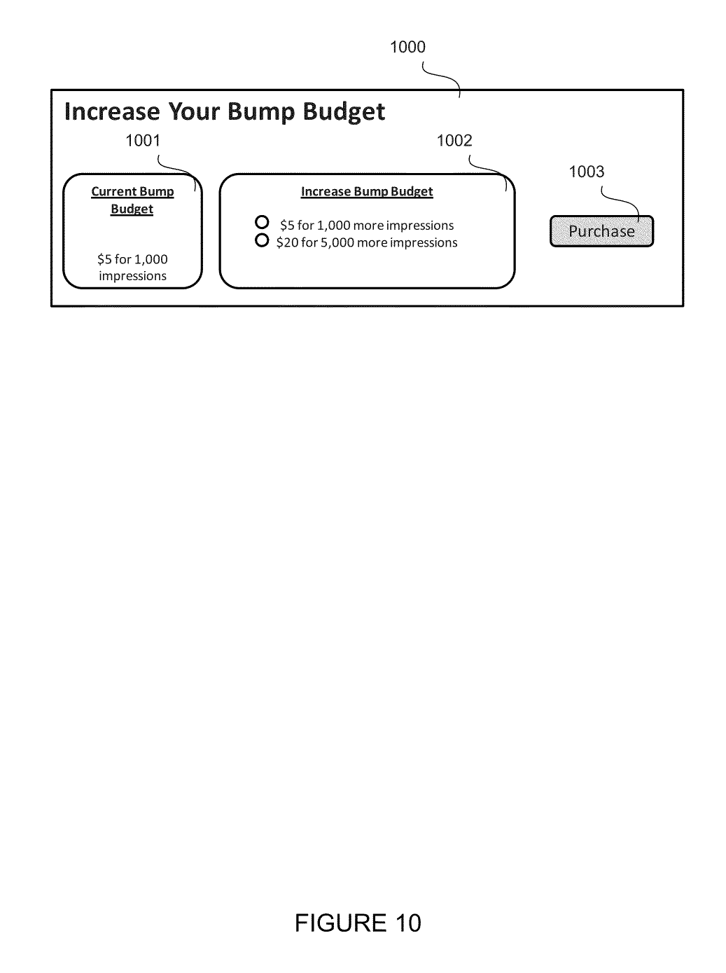

FIG. 10 illustrates an exemplary purchase screen 1000 of the advantage tool. Specifically, the purchase screen 1000 may allow the seller to increase their budget for bump impressions. The purchase screen 1000 is illustrated as including a current budget tab 1001, a budget increase tab 1002, and a purchase tab 1003. The current budget tab 1001 identifies a bump impression budget amount previously committed to by the seller for the product listing. In this case, the current budget tab 1001 identifies the seller has previously committed $5 for 1,000 bump impressions. The budget increase tab 1002 may include one or more options for allowing the seller to increase their bump impression budget. For example, budget increase tab 1002 includes a first option allowing the seller to purchase 1,000 bump impressions for $5, and a second option allowing the seller to purchase 5,000 bump impressions for $20. The advantage tool may be configured to generate one or more purchase options within the budget increase tab 1002 as illustrated in FIG. 10 so that the seller may select one of the generated purchase options. In addition or alternatively, the advantage tool may set a rate for purchasing bump impressions (e.g., $5/1000 bump impressions), thus allowing greater purchasing flexibility for the user. The purchase screen 1000 is also shown to include the purchase tab 1003, wherein the purchase option selected from the increase budget tab 1002 may be charged to the user by selection of the purchase tab 1003.

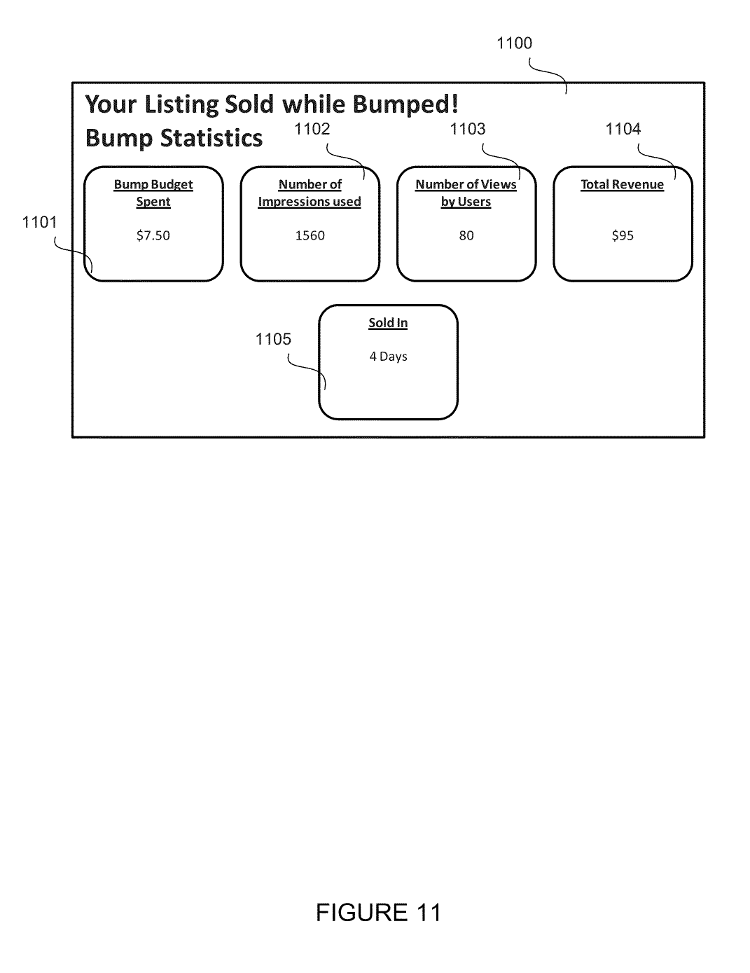

FIG. 11 illustrates an updated statistical table 1100 according to the advantage tool that includes statistical information on the sale of the product listing.

The updated statistical table 1100 includes a budget spent tab 1101 that identifies a monetary amount spent on bump impressions before the product listing sold, an impressions used tab 1102 that identifies an number of bump impressions used before the product listing sold, a views tab that identifies a number of views the product listing received from users of the electronic marketplace before being sold, a total revenue table 1104 that calculates income made by the seller from the sale of the product listing minus the cost of utilizing the bump impressions feature (e.g., the cost of utilizing the bump impressions feature may be the bump budget spend identified in the bump budget spent tab 1101), and a sold information tab 1105 that identifies a time period that passed before the product listing sold. The time period referenced in the sold information tab 1105 may correspond to a time from the product listing was first listed on the electronic marketplace to the time the product listing sold. In addition or alternatively, the time period reference in the sold information tab 1105 may correspond to a time from when the seller purchased bump impressions for the product listing to the time the product listing sold on the electronic marketplace.

As described earlier, the advantage tool may not actually charge the seller for enjoying the benefits of bump impressions until the product listing sells on the electronic marketplace. It follows that the seller may sign up their product listing for bump impressions with the advantage tool, the advantage tool may select the product listing for receiving the benefits of the bump impressions, and the seller may not have to pay for the received benefit of the bump impressions unless the product listing is sold. Further, in some embodiments the seller may not have to pay for more than the value of bump impressions enjoyed by the product listing at the time the product listing was sold.

As illustrated in FIGS. 7 and 8, the sub-display portion (e.g., sub-display 710 or sub-display 810) may be generated by the advantage tool to include a predetermined number of product listings. In the case of FIGS. 7 and 8, the sub-displays 710 and 810, respectively, have been generated by the advantage tool to include three product listings, although in other embodiments the number of product listings included in the sub-display may be increased or decreased.

In terms of the process for selecting product listings for inclusion into the sub-display, the advantage tool may analyze various factors. For example, the advantage tool may utilize a randomizer to randomly select a one or more product listings that are verified as having bump value remaining.

The advantage tool may also reference the product type category associated with a product listing in order to determine a popularity of the product type category. The popularity of the product type category may be determined by the advantage tool according to any one or more of the methods described throughout this disclosure. Then the advantage tool may select the product listing for inclusion in the sub-display based on the determined popularity of the product category. For example, in some embodiments the advantage tool may select one or more product listings that belong to a product type category having a popularity that exceeds a predetermined threshold.

Alternatively, in some embodiments the advantage tool may apply a greater weight to a product listing categorized within a more popular product type so that the product listing may have a higher probability of being selected for inclusion in the sub-display when analyzed alone or with other factors that have been described in this disclosure. The advantage tool may also apply a lesser weight to a product listing categorized within a less popular product type so that the product listing may have a lower probability of being selected for inclusion in the sub-display when analyzed alone or with other factors that have been described in this disclosure. Conversely, in some embodiments the advantage tool may apply a lower weight to a product listing categorized within a more popular product type so that the product listing may have a lower probability of being selected for inclusion in the sub-display when analyzed alone or with other factors that have been described in this disclosure. The advantage tool may also apply a greater weight to a product listing categorized within a less popular product type so that the product listing may have a higher probability of being selected for inclusion in the sub-display when analyzed alone or with other factors that have been described in this disclosure.

The advantage tool may also determine a likelihood of sale for a product listing to determine a likelihood that the product listing will be sold on the electronic marketplace. A likelihood of sale value may be determined for the product listing based on a number of views the product listing has enjoyed, where the greater number of views results in a higher likelihood of sale value for the product listing.

The likelihood of sale value may also be determined based on an analysis of product listing attributes (e.g., product listing type category, condition, location, brand, age, or other identifiable product listing attribute), where product listings having certain product listing attributes that are predetermined by the advantage tool may be assigned a higher likelihood of sale value.

The likelihood of sale value may also be determined based on an analysis of product listing attributes (e.g., product listing type category, condition, location, brand, age, or other identifiable product listing attribute) compared against the product listing purchase price assigned by the seller. The advantage tool may generate a target price for the product listing based on the product listing attributes. Then in some embodiments, a higher likelihood of sale value may be assigned to the product listing when the analysis finds that the product listing purchase price is closer to the target price. In some embodiments, a higher likelihood of sale value may be assigned to the product listing when the analysis finds that the product listing purchase price is lower than the target price.

The likelihood of sale value may also be determined based on historical purchasing information for same, or similar, product listings, where the greater number of sales for the same, or similar, product listings results in a higher likelihood of sale value for the product listing. A determination on the similarity of product listings may be determined based on a predetermined list of product type categories that are understood by the advantage tool as being similar for the purposes of determining the likelihood of sale.

After determining the likelihood of sale for the product listing according to any one or more of the methods described above, the advantage tool may select one or more product listings having a likelihood of sale value that satisfies (e.g., greater than) a predetermined threshold or condition.

Alternatively, after determining the likelihood of sale for the product listing, the advantage tool may apply a greater weight to the product listing when the likelihood of sale is higher so that the product listing may have a higher probability of being selected for inclusion in the sub-display when analyzed alone or with other factors that have been described in this disclosure. The advantage tool may also apply a lower weight to the product listing when the likelihood of sale is lower so that the product listing may have a lower probability of being selected for inclusion in the sub-display when analyzed alone or with other factors that have been described in this disclosure. Conversely, in some embodiments the advantage tool may apply a lower weight to the product listing when the likelihood of sale is greater so that the product listing may have a lower probability of being selected for inclusion in the sub-display when analyzed alone or with other factors that have been described in this disclosure. The advantage tool may also apply a greater weight to the product listing when the likelihood of sale is lower so that the product listing may have a higher probability of being selected for inclusion in the sub-display when analyzed alone or with other factors that have been described in this disclosure. As before, the advantage tool will check the bump value for the product listing to ensure sufficient bump value remains for the product listing to be included in the sub-display.

The advantage tool may also reference a number of times a product listing has been selected for a bump impression. Then in an effort to promote product listings that have not been selected as many times as other eligible product listings, the advantage tool may select one or more product listings for inclusion in the sub-display that have been selected less than other product listings.

Alternatively, the advantage tool may assign a greater weight to product listings that have not been selected as many times as other eligible product listings so that the product listing may have a higher probability of being selected for inclusion in the sub-display when analyzed alone or with other factors that have been described in this disclosure. The advantage tool may also assign a lower weight to product listings that have been selected more than other eligible product listings so that the product listing may have a lower probability of being selected for inclusion in the sub-display when analyzed alone or with other factors that have been described in this disclosure. Conversely, the advantage tool may assign a lower weight to product listings that have not been selected as many times as other eligible product listings so that the product listing may have a lower probability of being selected for inclusion in the sub-display when analyzed alone or with other factors that have been described in this disclosure. The advantage tool may also assign a greater weight to product listings that have been selected more than other eligible product listings so that the product listing may have a higher probability of being selected for inclusion in the sub-display when analyzed alone or with other factors that have been described in this disclosure. As before, the advantage tool will check the bump value for the product listing to ensure sufficient bump value remains for the product listing to be included in the sub-display.

The advantage tool may also reference certain user profiles in order to select product listings into the sub-display that may be of interest to the user being presented with the sub-display. By doing so, the advantage tool may populate the sub-display with product listings that are targeted to the specific user that will be viewing the sub-display.

As described above, the user initiates a session with the electronic marketplace by first accesses the electronic marketplace according to one or more of the methods described above. After accessing the electronic marketplace, the advantage tool may be configured to select one or more product listings for inclusion into the sub-display that will be included within a display of the electronic marketplace presented to the user. In some embodiments, accessing the electronic marketplace may include the user identifying himself/herself to the electronic marketplace such that a user profile for the user may be accessed by the electronic marketplace and the advantage tool. It for such embodiments where the advantage tool may have access to the user profile that the advantage tool may proceed to populate the sub-display with product listings that are targeted to the user.

The user profile may include user attributes corresponding to the user. Such user attributes may, for example, be the user's name, age, birthday, home address, work address, other address associated with the user, current location of the user, past purchase history of the user, a list of favorite products or product types, or other measurable user attribute that may be stored as part of the user's profile. The user profile may be stored, for example, on the marketplace server 103 that is also configured to host the electronic marketplace. In addition or alternatively, a portion or all of the user profile may be stored on a communication device being operated by the user to access the electronic marketplace. For example, the user's current position may be obtained by a GPS device running on a communication device being operated by the user to access the electronic marketplace, and the user's current position information may then be transmitted to the marketplace server 103 to be reference by the advantage tool. The list of user attributes to be stored within the user profile is provided for exemplary purposes only as it is within the scope of the disclosure for the advantage tool to access user profiles that include a greater, or fewer, number of user attributes.

When referencing the user profile in order to select a product listing for inclusion in the sub-display, the advantage tool may select a product listing having one or more product attributes that relate to one or more user attributes identified from the user profile. A product listing may have a product profile that identifies one or more product attributes for the product being listed. A product attribute may, for example, identify a product type or category, a location at which the product may be picked up when the product is a physical good, a location at which the product may be redeemed when the product is a service or redemption based (e.g., a restaurant offer being redeemed at the restaurant), a price for the product, an origin for the product (e.g., place of manufacture), a popularity score as graded by other users of the electronic marketplace, or other similarly measurable product attribute.

After analyzing the user profile for the user accessing the electronic marketplace and analyzing product profiles for one or more product listings, the advantage tool may compare the user profile against the product profiles of the one or more product listings that are part of the electronic marketplace inventory. In some embodiments the product listings considered by the advantage tool for selection into the sub-display may be limited to those product listings that are found to have remaining bump values. In some embodiments the product listings considered by the advantage tool for selection into the sub-display may be limited to certain product type categories selected by the user. In any case, the advantage tool may then select one or more product listings for inclusion into the sub-display based on the comparison that identifies product listings that may share a relationship with the user. For example, the advantage tool may select a set number of product listings that are determined to share the closest relationship with the user based on the comparison of the user profile and the product profiles of the selected product listings.

Alternatively, the advantage tool may assign a greater weight to product listings determined to have a closer relationship with the user so that such product listings may have a higher probability of being selected for inclusion in the sub-display. The advantage tool may also assign a lower weight value to product listings determined not to have a closer relationship with the user so that such product listings may have a lower probability of being selected for inclusion in the sub-display when analyzed with other factors that have been described in this disclosure. As before, the advantage tool will check the bump value for the product listing to ensure sufficient bump value remains for the product listing to be included in the sub-display.

Specific examples may find the advantage tool identifying the user's home address or other location information from the user profile. Based on the recognition of this user attribute, the advantage tool may select one or more product listings that are found to be located within a predetermined distance from the user's home address or other location identified in the user profile. In some embodiments, the advantage tool may apply a greater weight to the product listings that are found to be located within a predetermined distance from the user's home address or other location identified in the user profile such that the product listings may have a higher probability of being selected for inclusion into the sub-display when analyzed alone or with other factors that have been described in this disclosure.

The advantage tool may also analyze the user's past purchase history identified in the user profile and identify purchasing patterns. The advantage tool may then select one or more product listings having product attributes that fit into the purchasing pattern identified from the user's past purchase history.

Alternatively, in some embodiments the advantage tool may apply a greater weight to product listings that fit into the purchasing pattern identified from the user's past purchase history so that the product listings may have a higher probability of being selected for inclusion into the sub-display when analyzed alone or with other factors that have been described in this disclosure.

In this way, the advantage tool may offer a more targeted sub-display that better relates to the user viewing the sub-display.

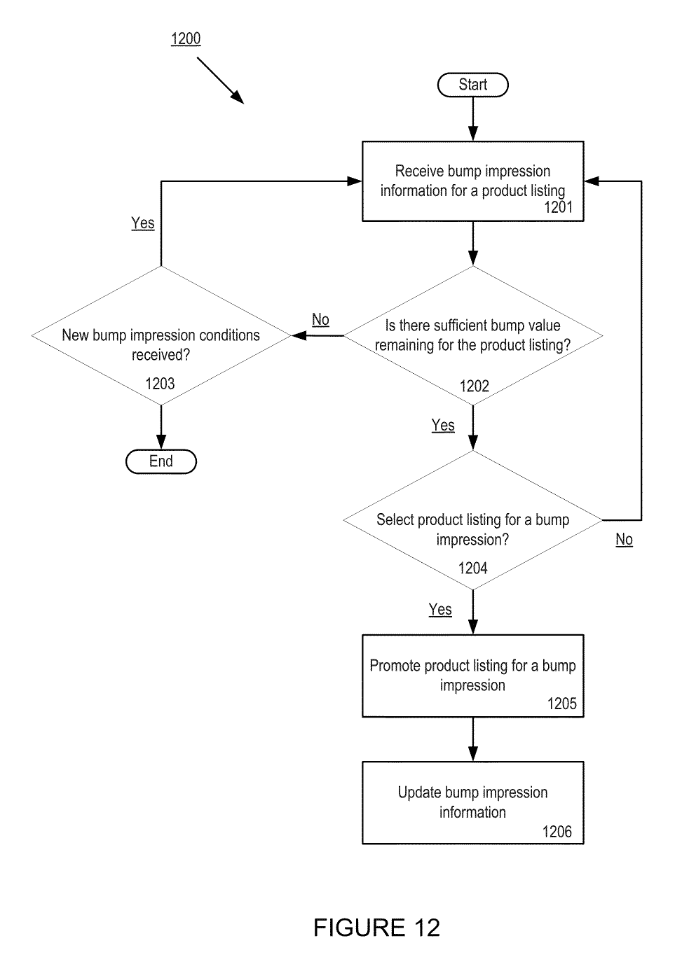

FIG. 12 illustrates a flow chart 1200 that describes a process for implementing the advantage tool according to some embodiments. More specifically, the flow chart 1200 described a process for determining whether to select a product listing for inclusion in a sub-display to be presented to a user accessing the electronic marketplace according to the innovation described herein.

At 1201, the advantage tool may parse information for a product listing to identify bump impression information corresponding to the product listing. For example, the advantage tool may access a product profile for the product listing to identify a bump value for the product listing.

At 1202, the advantage tool determines whether the product listing has sufficient bump value remaining to be considered for selection into the sub-display. If the product listing does not have enough bump value remaining, the advantage tool may provide for an opportunity to replenish or update the bump value. For example, a seller may be presented with purchase options at 1203 that may allow the seller to replenish or update the bump value as described with reference to FIG. 10 above. If the bump value is not replenished or updated at 1203, the process may be considered to have ended as the product listing will not be selected by the advantage tool. If, however, the bump value is replenished or updated at 1203, the process may revert back to 1201.

Assuming that the product listing is found to have sufficient bump value remaining at 1202, the process proceeds to 1204 where the advantage tool determines whether to select the product listing for a bump impression that will include the product listing in the sub-display. The determination of whether to select the product listing for the bump impression may be implemented according to any one or more of the methods described throughout this disclosure.

If the product listing is selected for the bump impression at 1204, then the advantage tool will implement the bump impression for the product listing. If the product listing is not selected for bump impression at 1204, then the advantage tool may revert the process to 1201.

After implementing the bump impression for the product listing, the advantage tool may update the bump impression information for the product listing at 1206. For example, the advantage tool may update the bump value for the product listing by decreasing the number of bump impressions remaining, and/or updating the running count of money spent on implemented bump impressions for the product listing. The updates to the bump impression information for the product listing may correspond to any one or more of the information points illustrated in statistical table 900 and/or statistical table 1100 described above.

Although not specifically illustrated, the bump impression information may also be updated when the product listing is sold. For example, after the sale of the product listing the updates to the bump impression information for the product listing may correspond to any one or more of the information points illustrated in statistical table 900 and/or statistical table 1100 described above. In particular, the total revenue tab 1104 and the sold information tab 1105 in statistical table 1100 may be updated after the product listing has sold.

The process described by flow chart 1200 is provided for exemplary purposes, as it is within the scope of the innovation disclosed herein for the advantage tool to implement a process that includes fewer, or more, steps than those described in flow chart 1200. In addition, the although flow chart 1200 is described in terms of a single product listing being analyzed for selection into the sub-display, the advantage tool may also be configured to analyze two or more product listings in parallel.

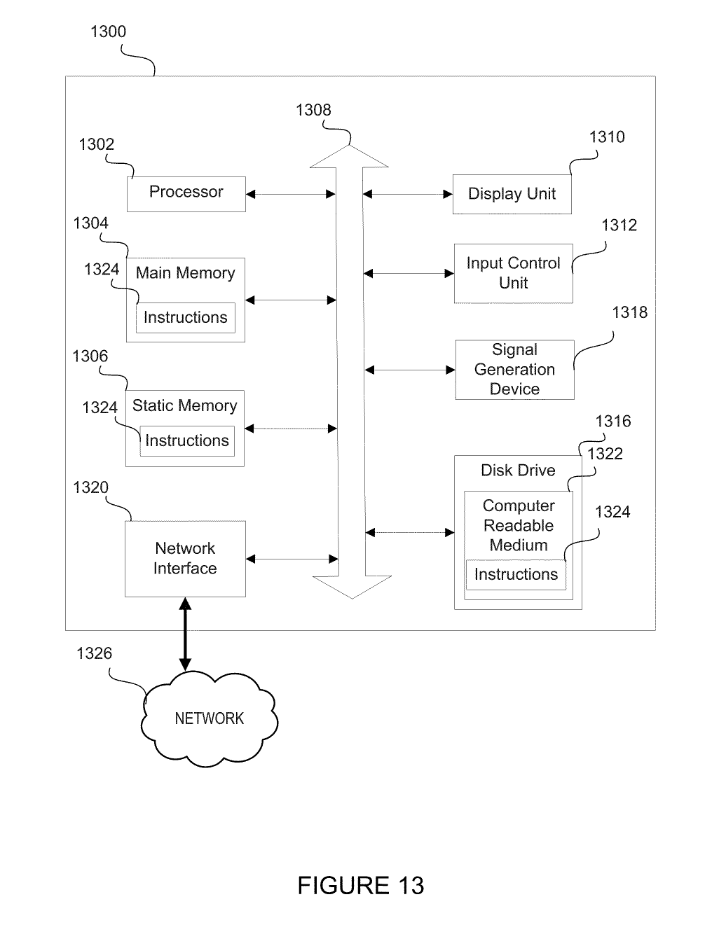

FIG. 13 includes an illustrative embodiment of a general computer system 1300 that may be used for one or more of the devices shown in FIG. 1, or in any other system configured to carry out the methods discussed above. For example, any one or more of the communication device 101, communication device 102, or the marketplace server 103, may be implemented as the computer system 1300.

The computer system 1300 can include a set of instructions that may be executed to cause the computer system 1300 to perform any one or more of the methods, processes or computer-based functions disclosed herein. For example, the marketplace tool or advantage tool may be a program that is comprised of a set of instructions 1324 that are executed to cause the communication device 101 or communication device 102 to perform any one or more of the methods, processes or computer-based functions described herein. The instructions may be stored in any one or more of the main memory 1304, static memory 1306, or disk drive 1316. The computer system 1300 may be mobile or non-mobile, operate as a stand-alone device, or may be connected using a network 1326, to other computer systems or peripheral devices. The computer system 1300 connected to the network 1326 can communicate voice, video or data over the network 1326 to another computer system via the network interface 1320. The computer system 1300 connected to the network 1326 can also receive voice, video or data over the network 1326 from another computer system via the network interface 1320. For example, the instructions 1324 may be transmitted or received over the network 1326 via the network interface device 1320. The network 1326 may correspond to the network 104 described in FIG. 1.

In a networked deployment, the computer system 1300 may operate in the capacity of a server or as a client operated communication device in a server-client user network environment, or as a peer computer system in a peer-to-peer (or distributed) network environment. The computer system 1300 can also be implemented as, or incorporated into, various devices, such as a personal computer (“PC”), a tablet PC, a set-top box (“STB”), a personal digital assistant (“PDA”), a mobile device such as a smart phone or tablet, a palmtop computer, a laptop computer, a desktop computer, a network router, switch or bridge, or any other machine capable of executing a set of instructions (sequential or otherwise) that specify actions to be taken by that machine. In a particular embodiment, the computer system 1300 can be implemented using electronic devices that provide voice, video or data communication. Further, while a single computer system 1300 is illustrated, the term “system” shall also be taken to include any collection of systems or sub-systems that individually or jointly execute a set, or multiple sets, of instructions to perform one or more computer functions.

As illustrated in FIG. 13, the computer system 1300 may include a processor 1302, such as a central processing unit (“CPU”), a graphics processing unit (“GPU”), or both. Moreover, the computer system 1300 may include any combination of a main memory 1304 and a static memory 1306 that can communicate with each other via a communication bus 1308. As shown, the computer system 1300 may further include a video display unit 1310, such as a liquid crystal display (“LCD”), an organic light emitting diode (“OLED”), a flat panel display, a solid state display, or a cathode ray tube (“CRT”). Additionally, the computer system 1300 may include an input control unit 1312 that includes one or more input devices such as a keyboard, scanner, digital camera for image capture and/or visual command recognition, touch screen, motion sensor, audio input device, or a cursor control device (e.g., mouse or touchpad). The computer system 1300 can also include a disk drive unit 1316 for receiving a computer readable medium 1322, a signal generation device 1318 (e.g., a speaker system or remote control signal output system), and a network interface 1320.

In some embodiments, as depicted in FIG. 13, the disk drive unit 1316 may receive the computer-readable medium 1322 in which one or more sets of instructions 1324, such as software, can be embedded. Further, the instructions 1324 may embody one or more of the methods, processes, or logic as described herein such as the marketplace tool and/or advantage tool. In some embodiments, the instructions 1324 may reside completely, or at least partially, within the main memory 1304, the static memory 1306, and/or within the processor 1302 during execution of the instructions 1324 by the computer system 1300. The main memory 1304 and the processor 1302 also may include computer-readable media.

In an alternative embodiment, dedicated hardware implementations, including application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any tangible medium that is capable of storing, encoding or carrying a set of instructions for execution by a processor or that cause a computer system to perform any one or more of the methods or operations disclosed herein.

In some embodiments, the computer-readable medium can include a solid-state memory such as a memory card or other package that houses one or more non-volatile read-only memories, such as flash memory. Further, the computer-readable medium can be a random access memory or other volatile re-writable memory. Additionally, the computer-readable medium can include a magneto-optical or optical medium, such as a disk or tapes or other storage device to capture information communicated over a transmission medium. A digital file or digital information that is transmitted or received over the network 1326 may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

Any process descriptions or blocks in the figures, should be understood as representing modules, segments, or portions of code which include one or more executable instructions for implementing specific logical functions or steps in the process, and alternate implementations are included within the scope of the embodiments described herein, in which functions may be executed out of order from that shown or discussed, including substantially concurrently or in reverse order, depending on the functionality involved, as would be understood by those having ordinary skill in the art.

It should be emphasized that the above-described embodiments, particularly, any “preferred” embodiments, are possible examples of implementations, merely set forth for a clear understanding of the principles of the invention. Many variations and modifications may be made to the above-described embodiment(s) without substantially departing from the spirit and principles of the techniques described herein. All such modifications are intended to be included herein within the scope of this disclosure and protected by the following claims.

1.-20. (canceled)

21. A computing device, comprising:
a memory configured to store processor executable instructions;
a network interface configured to receive communications from user operated devices; and
a processor in communication with the memory and the network interface, the processor configured to execute the processor executable instructions stored on the memory to:
receive product listing information for a product listing that includes an impression value for the product listing;
determine the product listing is eligible for an impression function when the impression value satisfies a threshold value;
analyze the product listing information for selection of the impression function;
select the product listing for the impression function based on the analysis, and
control a display unit to present the product listing within a sub-display area within a general display in accordance to the impression function.

22. The computing device of claim 21, wherein the processor is further configured to execute the processor executable instructions stored on the memory to:
update the product listing information in response to the product listing being displayed in the sub-display area in accordance to the impression function.

23. The computing device of claim 21, wherein the processor is further configured to execute the processor executable instructions stored on the memory to:
control the sub-display to be displayed with contrast against the general display.

24. The computing device of claim 21, wherein the processor is further configured to execute the processor executable instructions stored on the memory to:
assign a monetary charge amount for each instance the product listing is selected for the impression function;
analyze the product listing information and determine whether the product listing has been sold based on the analysis of the product listing information;
determine a number of times the product listing was selected for the impression function prior to the product listing being sold;
determine a total charge amount based on the monetary charge amount and the number of times the product listing was selected for the impression function prior to the product listing being sold, and
control the display unit to present the total charge amount.

25. The computing device of claim 24, wherein the processor is further configured to not present the total charge amount when the product listing is determined not to have been sold.

26. The computing device of claim 21, wherein the processor is further configured to execute the processor executable instructions stored on the memory to:
determine the product listing is not eligible for the impression function when the impression value does not satisfy the threshold value;
receive new product listing information identifying the impression value has been updated, and
determine the product listing is eligible for the impression function when the updated impression value satisfies the threshold value.

27. The computing device of claim 21, wherein the processor is configured to execute the processor executable instructions stored on the memory to select the product listing for the impression function when the analysis of the product listing information determines the product listing qualifies for selection of the impression function.

28. The computing device of claim 21, wherein the processor is configured to execute the processor executable instructions stored on the memory to analyze the product listing information to determine a likelihood of sale for the product listing, and
wherein the processor is configured to select the product listing for the impression function when the likelihood of sale satisfies a predetermined condition.

29. The computing device of claim 21, wherein the processor is configured to execute the processor executable instructions stored on the memory to analyze the product listing information to determine a number of times the product listing has previously been selected for the impression function, and
wherein the processor is configured to select the product listing for the impression function when the number of times the product listing has been previously selected for the impression function is less than a predetermined amount.

30. The computing device of claim 21, wherein the processor is further configured to execute the processor executable instructions stored on the memory to:
identify a user that will be presented the sub-display area;
access a user profile of the user, and identify a location of the user from the user profile;
identify a location of the product listing from the product listing information;
determine a distance between the location of the user and the location of the product listing, and
select the product listing for the impression function when the distance between the location of the user and the location of the product listing is less than a predetermined distance.

31. The computing device of claim 21, wherein the sub-display area is located above a secondary display area including one or more other product listings that are different from the product listing presented within the sub-display.

32. A method for providing an advantage for a product listing, comprising:
receiving product listing information for the product listing that includes an impression value for the product listing;
determining the product listing is eligible for an impression function when the impression value satisfies a threshold value;
analyzing the product listing information for selection of the impression function;
selecting the product listing for the impression function based on the analysis, and
controlling a display unit to present the product listing within a sub-display area within a general display in accordance to the impression function.

33. The method of claim 32, further comprising:
updating the product listing information in response to the product listing being displayed in the sub-display area in accordance to the impression function.

34. The method of claim 32, further comprising:
controlling the sub-display to be displayed with contrast against the general display.

35. The method of claim 32, further comprising:
assigning a monetary charge amount for each instance the product listing is selected for the impression function;
analyzing the product listing information and determine whether the product listing has been sold based on the analysis of the product listing information;
determining a number of times the product listing was selected for the impression function prior to the product listing being sold;
determining a total charge amount based on the monetary charge amount and the number of times the product listing was selected for the impression function prior to the product listing being sold, and
controlling the display unit to present the total charge amount.

36. The method of claim 32, further comprising:
determining the product listing is not eligible for the impression function when the impression value does not satisfy the threshold value;
receiving new product listing information identifying the impression value has been updated, and
determining the product listing is eligible for the impression function when the updated impression value satisfies the threshold value.

37. The method of claim 32, wherein selecting the product listing for the impression function comprises selecting the product listing for the impression function when the analysis of the product listing information determines the product listing qualifies for selection of the impression function.

38. The method of claim 32, further comprising:
analyzing the product listing information to determine a likelihood of sale for the product listing, and
selecting the product listing for the impression function when the likelihood of sale satisfies a predetermined condition.

39. The method of claim 32, further comprising:
analyzing the product listing information to determine a number of times the product listing has previously been selected for the impression function, and
selecting the product listing for the impression function when the number of times the product listing has been previously selected for the impression function is less than a predetermined amount.

40. The method of claim 32, further comprising:
identifying a user that will be presented the sub-display area;
accessing a user profile of the user, and identify a location of the user from the user profile;
identifying a location of the product listing from the product listing information;
determining a distance between the location of the user and the location of the product listing, and
selecting the product listing for the impression function when the distance between the location of the user and the location of the product listing is less than a predetermined distance.

41. The method of claim 32, wherein the sub-display area is located above a secondary display area including one or more other product listings that are different from the product listing presented within the sub-display.
